(19) United States
(12) Patent Application Publication
(10) Pub. No.: US 2026/0267758 A1
(43) Pub. Date: Sep. 10, 2026

(54) DETECTING AND MANAGING RESOURCE DRIFT IN CLOUD COMPUTING ENVIRONMENTS

(71) Applicant: Oracle International Corporation, Redwood Shores, CA (US)

(72) Inventors: Yannick Roger Denis Ongena, Drongen (BE); Farouk Ahmad Khan, Austin, TX (US); Navdeep Singh Bawa, Bothell, WA (US)

(73) Assignee: Oracle International Corporation, Redwood Shores, CA (US)

(21) Appl. No.: 19/069,840

(22) Filed: Mar. 4, 2025

(51) Int. Cl. G06F 11/30; G06F 11/32; H04L 41/0894

(52) U.S. Cl. CPC G06F 11/3006; G06F 11/323; H04L 41/0894

(57) ABSTRACT

Techniques discussed herein relate to automatically detecting and managing resource drift (e.g., differences between a requested/actual state and a predefined or approved state) corresponding to a set of resources of a cloud computing environment (e.g., resources of a landing zone environment). Requested changes may be intercepted before applied and a determination of whether to allow or reject the changes may be made based at least in part on contextual data corresponding to the user/entity/resource to which the requested change applies. Previously-applied changes may be detected (e.g., based on current/approved state data comparisons) and a determination of whether to allow the change to persist or to remediate the change may be similarly made based at least in part on contextual data. User interfaces may be provided to view the resource drift across a cloud computing environment. User input for allowing/rejecting/reverting resource changes may be obtained via these interfaces.

### BACKGROUND

Cloud providers offer users the ability to deploy and configure various cloud computing components according to a pre-defined configuration. The pre-defined configuration (e.g., a template, a “Landing Zone,” etc.) may be defined and provided by the cloud provider such that the pre-defined configuration adheres to security, network, and compliance best practices. A user may select and customize a pre-defined configuration with compartment names, virtual cloud network properties, and the like. Deployments may be executed in accordance with the pre-defined/customized configuration to deploy a secure environment (e.g., a “Landing Zone Environment”) with which a user may execute various workloads. These techniques enable users to focus on migrating their workloads without having to design or architect the environment in which those workloads will execute. Post deployments, changes made be made to the environment and corresponding resources over time. Managing and monitoring compliance to regulatory controls and/or drift (e.g., changes from the deployed configuration, changes made to the environment and/or corresponding components over time, etc.) is cumbersome and time-consuming and requires extensive manual effort. This is especially burdensome for users that manage multiple secure environments.

### BRIEF SUMMARY

Techniques are provided for providing for detecting and controlling deployment drift (e.g., changes made to a Landing Zone Environment over time). Various embodiments are described herein, including methods, systems, non-transitory computer-readable storage media storing programs, code, or instructions executable by one or more processors, and the like.

One embodiment is directed to a method for detecting and controlling deployment drift. The method may comprise monitoring a cloud-computing environment comprising a set of resources. In some embodiments, the set of resources may be previously deployed to the cloud-computing environment as part of executing an automated deployment process. The set of resources may be deployed by the automated deployment process based at least in part on a predefined cloud-computing architecture. The method may comprise maintaining, for the set of resources of the cloud-computing environment, approved state data indicating an approved state of the set of resources of the cloud-computing environment. The method may comprise receiving drift data indicating a difference between a requested state of the set of resources and the approved state of the set of resources. The method may comprise identifying an entity to which the difference is attributable. The method may comprise, responsive to determining that the entity to which the difference is attributable is allowed to modify one or more resources corresponding to the difference, performing one or more operations to modify the set of resources in accordance with the requested state.

In some embodiments, the drift data is first drift data, and the computer-implemented method further comprises receiving second drift data indicating a second difference between a corresponding requested state of an additional resource of the cloud-computing environment and a corresponding approved state of the additional resource. In some embodiments, the additional resource may have been deployed using an additional predefined code module that specifies an additional deployed state of the additional resource. The method may comprise determining aggregated drift data associated with the cloud-computing environment based at least in part on combining the first drift data and the second drift data. In some embodiments, performing the one or more operations is further based on the aggregated drift data.

The method may further comprise causing the difference to be presented at a user interface. The method may further comprise receiving, from the user interface, user input indicating a modification corresponding to the difference is approved. In some embodiments, performing the one or more operations is further based at least in part on determining that the user input indicates the modification corresponding to the difference is approved.

The method may comprise maintaining a last approved state of the set of resources. In some embodiments, performing the one or more operations comprises updating the last approved state of the set of resources.

In some embodiments, the requested state is received in a change request. The method may further comprise 1) determining whether the entity to which the difference is attributable is allowed to modify the one or more resources corresponding to the difference, and 2) rejecting the change request based at least in part on determining that the entity to which the difference is attributed is not allowed to modify the one or more resources corresponding to the difference.

In some embodiments, determining that the entity to which the difference is attributable is allowed to modify one or more resources comprises identifying that the entity to which the difference is attributable is a resource manager configured to deploy resources to the cloud-computing environment.

In some embodiments, the method may comprise maintaining a plurality of change policies, wherein determining that the entity to which the difference is attributable is allowed to modify the one or more resources corresponding to the difference is based at least in part on identifying a change policy of the plurality of change policies. In some embodiments, the change policy may be associated with the entity and indicating that the entity is allowed to modify corresponding resources associated with a resource type.

A computing device is disclosed. The computing device may comprise one or more processors and one or more memories that store computer-executable instructions that, when executed by the one or more processors, cause the computing device/the one or more processors to perform any of the disclosed methods. One such method may comprise monitoring a cloud-computing environment comprising a set of resources. In some embodiments, the set of resources may be previously deployed to the cloud-computing environment as part of executing an automated deployment process. The set of resources may be deployed by the automated deployment process using a predefined code module that specifies a deployed state of the set of resources. The method may comprise maintaining, for the set of resources of the cloud-computing environment, expected state data indicating an expected state of the set of resources of the cloud-computing environment. The method may comprise receiving or obtaining drift data that indicates a change to a resource of the set of resources of the cloud-computing environment has occurred. The method may comprise determining that the change is attributable to an entity. The method may comprise performing one or more operations based at least in part on determining that the change is attributable to the entity.

In some embodiments, the drift data is received from a resource manager configured to deploy resources to the cloud-computing environment.

In some embodiments, executing the computer-executable instructions that determine the change is attributable to the entity further causes the computing device/one or more processors to determine whether the entity is a resource manager configured to deploy resources within the cloud-computing environment. In some embodiments, performing the one or more operations is further based on determining whether the entity is the resource manager.

In some embodiments, performing the one or more operations is further based at least in part on determining that the entity is a code module associated with a deployment.

In some embodiments, executing the computer-executable instructions that determine the change is attributable to the entity further causes the computing device/one or more processors to 1) obtain, from a resource type manager, metadata associated with the resource of the set of resources, and 2) identify the entity from the metadata associated with the resource based on identifying, from the metadata, that the entity caused a last modification of the resource.

In some embodiments, executing the computer-executable instructions further causes the computing device/one or more processors to 1) determine that the entity is a user; and 2) determine, from one or more predefined policies, whether the user is allowed to modify the resource.

In some embodiments, executing the one or more operations causes the computing device/one or more processors to automatically allow the change to persist, or to automatically reverse the change.

A non-transitory computer-readable medium is disclosed. The non-transitory computer-readable medium may comprise one or more memories storing computer-executable instructions that, when executed by one or more processors, cause the one or more processors to perform any of the disclosed methods. One such method may comprise monitoring a cloud-computing environment comprising a set of resources. In some embodiments, the set of resources may be previously deployed to the cloud-computing environment as part of executing an automated deployment process according to a predefined architectural template that specifies a post-deployment state of the set of resources and an architecture framework of the cloud-computing environment. In some embodiments, the method may comprise maintaining, for the set of resources of the cloud-computing environment, expected state data indicating an expected state of the set of resources of the cloud-computing environment. In some embodiments, the method may comprise receiving drift data that indicates a change to a resource of the set of resources of the cloud-computing environment. The method may comprise determining that the change is attributable to an entity. The method may comprise performing one or more operations based at least in part on determining that the change is attributable to the entity.

In some embodiments, the one or more operations performed comprise applying the change to the resource. In some embodiments, executing the computer-executable instructions further causes the one or more processors to update the expected state data based at least in part on applying the change to the resource.

In some embodiments, executing the computer-executable instructions further causes the one or more processors to 1) maintain a plurality of policies, at least one policy of the plurality of policies indicating that the entity is allowed to modify resources of a first resource type, and 2) determine that the resource is associated with the first resource type, wherein the one or more operations performed comprise effectuating the change, and wherein the one or more operations are performed further based at least in part on determining that the resource is associated with the first resource type.

In some embodiments, executing the computer-executable instructions further causes the one or more processors to 1) maintain a plurality of policies, at least one policy of the plurality of policies indicating that the entity is allowed to modify resources of a first resource type, and 2) determine that the resource is associated with a second resource type that differs from the first resource type, wherein performing the one or more operations comprise rejecting the change based at least in part on determining that the resource is associated with the second resource type that differs from the first resource type.

In some embodiments, executing the computer-executable instructions further causes the one or more processors to 1) present the drift data that indicates the change to the resource of the set of resources of the cloud-computing environment, 2) receive user input indicating the change is to be reversed, and 3) execute additional operations to reverse the change based at least in part on receiving the user input.

In some embodiments, executing the computer-executable instructions further causes the one or more processors to 1) present the drift data that indicates the change to the resource of the set of resources of the cloud-computing environment has occurred, 2) receive user input indicating the change is to be applied, and 3) execute additional operations to apply the change based at least in part on receiving the user input.

### BRIEF DESCRIPTION OF THE DRAWINGS

FIG. 1 illustrates a block diagram illustrating a cloud computing environment, according to at least one embodiment.

FIG. 2 is a block diagram depicting control plane and data plane components of a cloud computing environment, according to at least one embodiment.

FIG. 3 is a block diagram depicting a method for determining a remedial action corresponding to an intended or previously-applied change to a landing zone resource, according to at least one embodiment.

FIG. 4 illustrates a flow depicting an example method for training one or more machine-learning models, in accordance with at least one embodiment.

FIG. 5 is a schematic of an example user interface, according to at least one embodiment.

FIG. 6 is a schematic of another example user interface, according to at least one embodiment.

FIG. 7 is a schematic of yet another example user interface, according to at least one embodiment.

FIG. 8 illustrates an example computer architecture for a decision engine, according to at least one embodiment.

FIG. 9 is a block diagram illustrating an example method for detecting and responding to requested resource changes, according to at least one embodiment.

FIG. 10 is a block diagram illustrating an example method for detecting and responding to resource drift, according to at least one embodiment.

FIG. 11 is a block diagram illustrating one pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating another pattern for implementing a cloud infrastructure as a service system, according to at least one embodiment.

FIG. 14 is a block diagram illustrating another pattern for implementing a cloud infrastructure as a service system, according to at least one embodiment.

FIG. 15 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The disclosed techniques are directed to detecting and managing drift (e.g., requested resource changes, changes that were previously applied to cloud resources) within a cloud computing environment (e.g., a landing zone environment). A “landing zone environment” refers to a secure cloud computing environment that has been deployed and configured in accordance with a pre-defined configuration. This pre-defined configuration may be referred to as a “template” or a “landing zone” and may be defined by a cloud provider and used to provide a standardized and structured cloud environment setup that adheres to security, network, and compliance (e.g., regulatory compliance) best practices. These templates help enable users to easily provision a secure foundation in the cloud which can then reliably scale as their workloads expand. Conventionally, users were responsible for managing and identifying changes to their landing zone environments. These changes were cumbersome to identify and largely required manual effort. It can be difficult for a user to identify whether requested or actual changes to environment resources adhere to change management/access policies, deviate from best practices, or violate compliance standards.

A resource manager may be configured to detect requested/previously-performed changes to resources (e.g., infrastructure and/or software resources) of a landing zone environment. Detecting these changes may include comparing a state file that identifies current and/or approved attribute values associated with a given resource to attribute values corresponding to a requested or previously-applied resource change. In some embodiments, resource changes (e.g., requested or previously-applied changes) across any suitable number of resources may be aggregated to identify an aggregated drift (e.g., a collection of requested or previously-applied changes for each resource of a set of resources). Drift data identifying the aggregated drift (e.g., each requested or previously-applied change that deviates from the current/approved state of the resources) may be presented to user via one or more user interfaces. The user may be afforded options at the one or more user interfaces to view, approve, reject, or remediate various resource changes, before and/or after the resource change is applied. Application of least some of the detected resource changes may be automatically managed by the system. For example, contextual information related to the resource change (e.g., attributes of the applicable resource and/or attributes of the user corresponding to a change/change request) may be used to determine whether the resource change is automatically approved, rejected, remediated, etc. In some embodiments, a machine-learning model may be trained and/or utilized to identify a remedial action (e.g., operations to be performed in response to a change request and/or a previously applied change).

The disclosed techniques enable resource changes to be aggregated across an entire landing zone and presented to a user prior to or after applying the resource changes, which can improve the user's ability to quickly access an accurate representation of their landing zone environment as well as manage and understand landing zone resource changes. Aggregating configuration changes/deviations across the landing zone environments allows users to mitigate the risk of operational discrepancies, leading to a more stable and secure cloud infrastructure. The disclosed techniques enable the early identification and resolution of configuration drift and enable users and the system to proactively manage landing zone environments.

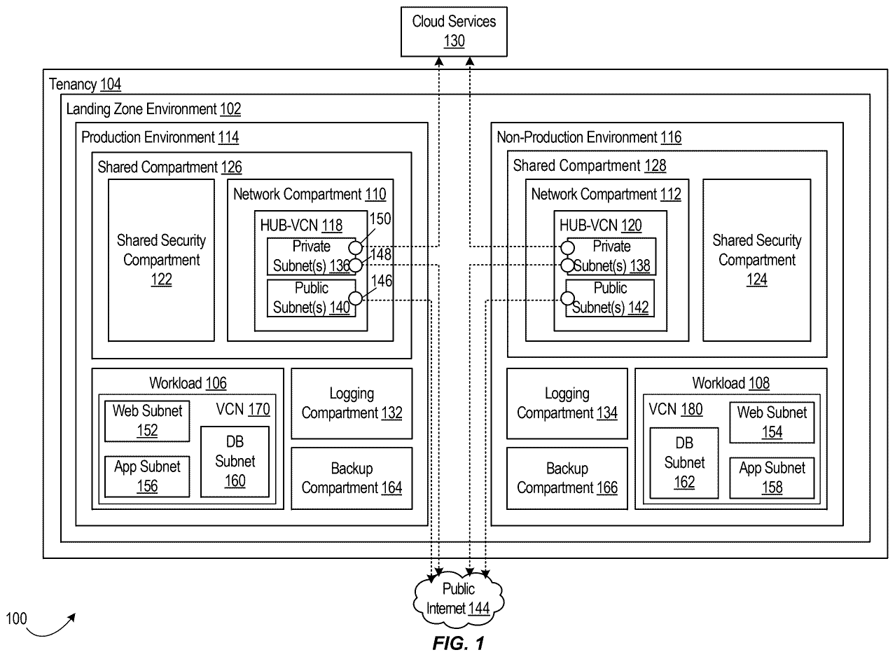

FIG. 1 illustrates a block diagram illustrating a cloud computing environment (e.g., environment 100), according to at least one embodiment. Environment 100 may include landing zone environment 102. The resources of the landing zone environment 102 may be deployed in accordance with one or more predefined-templates (also referred to as “landing zones” or “templates,” for brevity). Landing zone environment 102 may be an example of an Oracle Enterprise Landing Zone (e.g., a set of services and components that are deployed to an Oracle Cloud Infrastructure (OCI) tenancy according to one or more predefined templates). A template may include any suitable number of code segments that define infrastructure and/or software resources of the landing zone environment. As a non-limiting example, a template may include one or more Terraform code segments that each identify, via declarative statements, a desired state of one or more infrastructure and/or software resources. In some embodiments, users may have multiple landing zone environments similar to the one depicted in FIG. 1.

Landing zone environment 102 may be a highly segregated, functional environment within a customer tenancy (e.g., tenancy 104) to which workloads (e.g., workload 106 and workload 108) may be securely deployed. In some embodiments, landing zone environment 100 includes shared compartments 126 and 128. Shared compartments 126 and 128 may include network compartments 110 and 112, respectively, each of which may include network resources that conform to a hub-and-spoke network architecture. By way of example, network compartment 110 may be provided within a production environment (e.g., production environment 114) and network compartment 112 may be provided within a non-production environment (e.g., non-production environment 116), the resources of each being isolated from one another. A hub-and-spoke architecture refers to a network design pattern in which a central hub network is connected to multiple spoke networks. A hub network (e.g., hub-VCN 118, hub-VCN 120, etc.) may be used for shared resources such as shared security resources within a shared compartment (e.g., shared security resources within shared security compartment 126, shared security resources shared security compartment 128, etc.) and core services (e.g., cloud services 130), while the spoke networks may be used for individual workloads and/or applications. The hub network may be created using a virtual cloud network (VCN) in a network shared infrastructure compartment (e.g., network compartment 110, network compartment 112, etc.) using VCN attachment through a dynamic routing gateway. This may allow spoke networks to access shared resources in the hub network while maintaining their isolation.

The workloads 106 and 108 may include network resources of a spoke network which may be communicatively connected (e.g., via dynamic routing gateways, not depicted) to the hub network (e.g., hub-VCNs 118 and 120, respectively). Private subnet(s) 136 and 138 of the hub-VCNs 118 and 120 may host common or shared services that each environment (e.g., production environment 114, non-production environment 116, etc.) uses. Public subnet(s) 140 and 142, respectively, may host internet-facing servers and resources, including load balancers and web servers. An internet gateway (e.g., internet gateway 146) may be provided to allow traffic between public subnets in a VCN (e.g., public subnets) 140 and 142) and a public Internet (e.g., public internet 144). NAT gateways (e.g., NAT gateway 148) may be deployed to enable private resources in a VCN to access hosts on the public internet 144 without exposing the resources to incoming internet connections. In some embodiments, a service gateway (e.g., service gateway 150) may be provided in a VCN to provide access from a VCN to other services (e.g., cloud services 130).

Workloads 106 and 108 may include VCNs (e.g., VCN 170, VCN 180, respectively) that host subnets of a spoke network. By way of example, each of VCNs 170 and 180 may include private subnets to host various components of an application using different tiers, such as a web subnet (e.g., web subnet 152, web subnet 154, etc.), an app subnet (e.g., app subnet 156, app subnet 158, etc.), and a database subnet (e.g., DB subnet 160, DB subnet 162, etc.). In some embodiments, VCN attachments (not depicted) may connect VCNs 170 and 180 to the dynamic routing gateway of hub-VCNs 118 and 120, respectively.

Landing zone environment 102 may include a set of pre-built policies and guardrails that help ensure a strong foundation for achieving security compliance goals. The security controls implemented within landing zone environment 102 may be configured to achieve CIS 1.2, compliance Level 1. The Center for Internet Security, Inc. (CIS) is a non-profit organization that is community driven and is responsible for CIS Controls and CIS Benchmarks global best practices for securing IT systems and data. The goal of CIS is to prevent and mitigate new cyber threats that are identified in the industry. The shared security resources 122 and 124 may implement support for these CIS Benchmarks and/or similar compliance standards. Shared security resources 122 and 124 may individually include resources that provide vulnerability scanning, key management, network firewalls, and/or any suitable resource configured to enforce security policy and/or compliance requirements. By way of example, shared security resources 122 and 124 may include a “cloud guard service.” A cloud guard service may be a security service that is configured to monitor, identify threats and configuration issues, achieve a strong security posture, and maintain compliance with security policies. When issues are detected, a cloud guard service may be configured to recommend, assist, or execute corrective actions based on how the service is configured to respond. The cloud guard service may be configured with rules to detect resource configuration settings that could pose a security problem, rules to detect rogue user activity and/or high-risk activity, rules to detect actions on resources that could pose a security problem, and defined sets of actions to take in response to each problem.

Production environment 114 and non-production environment 116 may be isolated. Each of these environments may provide a separate identity domain such that users of one environment do not have access to resources of another environment. Each of these environments may include separate logging and monitoring resources within a logging compartment (e.g., logging compartment 132, logging compartment 134, etc.). Logging compartments 132 and 134 may include logging resources that provide the ability to record events and activities within the respective environments in which they are configured. These recorded events and activities may be used for auditing, debugging, and analyzing trends. In some embodiments, logging compartments 132 and 134 may individually include an immutable storage buck in which logs and events may be archived. Services within landing zone environment 102 and/or cloud services 130 may provide metrics and events that can be monitored through a metrics dashboard and alerts may be generated based on certain queries of the metrics and events.

Backup compartment 164 and backup compartment 166 may include configuration and/or state files corresponding to each resource within corresponding environment (e.g., production environment 114 and non-production environment 116, respectively).

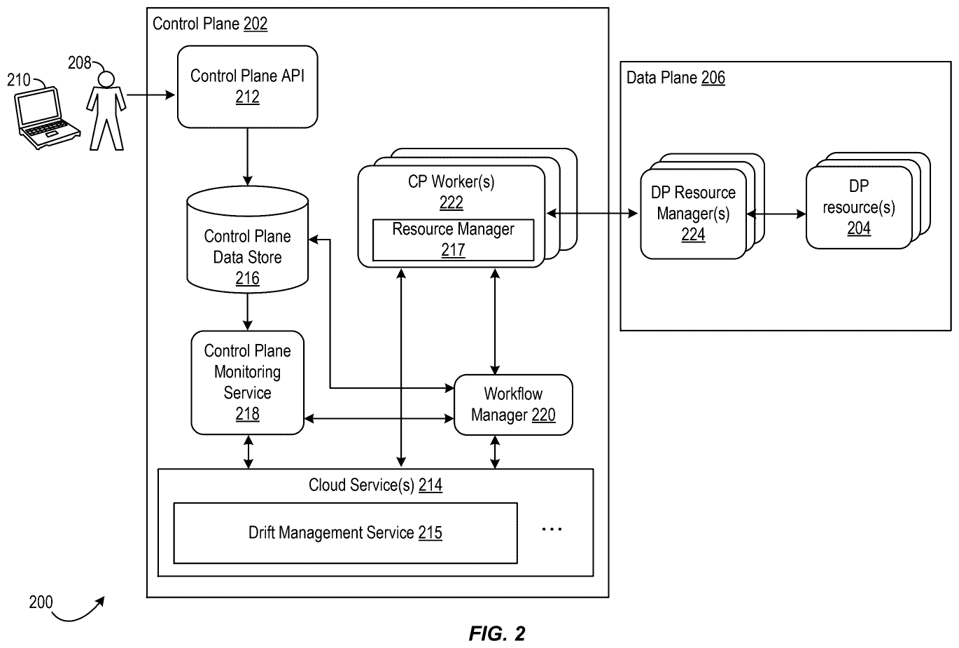

FIG. 2 is a block diagram depicting control plane and data plane (DP) components of a cloud computing environment 200, according to at least one embodiment. The components of control plane 202 may be used to effectuate changed to DP resource(s) 204 of data plane 206 (e.g., resource changes initiated by a user 208 via user device 210 and/or resource changes initiated by another entity, such as another DP resource). DP resource(s) 204 may be an example of a set of one or more resources (e.g., landing zone resources such as services, compartments, modules, subnets, VCNs, etc. depicted in FIG. 1).

In some embodiments, user 208 may initiate a resource change request via user device 210. A resource change request may include requested state data that describes a desired state of a set of one or more data plane resources (e.g., DP resource(s) 204). A resource change request may pertain to a new resource that has yet to be created, or a preexisting resource of DP resource(s) 204. A request change request may be received by control plane application programming interface (API) 212. In some embodiments, control plane API 212 may be one of cloud service(s) 214 (each of which may be an example of the cloud services 130 of FIG. 1). Control plane API 212 may be configured to receive any suitable number of resource change requests corresponding to one or more data plane resources.

A resource change request may include a request identifier and requested state data. The request identifier may uniquely identify the resource change request such that the resource change request can be distinguishable from other resource change requests. Requested state data may include any suitable number of attributes and attribute values that specify various aspects requested for a data plane resource including, but not limited to, an identifier for the resource, an availability domain, a shape, a number of processing units of the resource, an amount of random access memory (RAM) of the resource, an amount of disk memory, a role (e.g., a data node, a master node, etc.), a status (e.g., healthy), or the like. In some embodiments, the control plane API 212 may be configured to store all received resource change requests in a data store (e.g., a distributed data store) configured to store such information (e.g., control plane (CP) data store 216).

In some embodiments, CP data store 216 may be configured to store resource change requests and/or requested state data corresponding to a desired state requested for the data plane resource(s) 204. In some embodiments, the CP data store 216 may be configured to store a mapping of one or more data plane identifiers (DPIDs) of DP resource(s) 204 with requested/desired state data and/or current state data (e.g., data that indicates a current state of a DP resource). Current state data (sometimes referred to as “actual state data”) corresponds to one or more attributes/attribute values that identify the current attributes/attributes values corresponding a DP resource of the DP resource(s) 204.

The control plane 202 may include a control plane (CP) monitoring component 218. The CP monitoring service 218 may be configured to periodically (e.g., according to a predetermined frequency, schedule, etc.) determine whether requested state data received by the control plane API 212 and stored in the CP data store 216 (e.g., from a previously received resource change request) matches current state data stored for a corresponding DP resource (if that DP resource currently exists). When a difference between requested state data and current state data is identified for a given DP resource, the CP monitoring service 218 may be configured to invoke the functionality workflow manager 220. By way of example, if the CP monitoring service 218 determines that the current state data of a DP resource is not in line with (e.g., does not match) the requested state data stored in CP data store 216, CP monitoring service 218 may execute a function call to invoke the functionality of workflow manager 220.

In some embodiments, workflow manager 220 may be configured to identify one or more predefined workflows which individually identify operations to perform to configure DP resource(s) 204 in accordance with corresponding requested state data. In some embodiments, the workflow manager 220 may be configured to initiate one or more workers of control plane (CP) worker(s) 222 and forward the workflow instructions and/or requested state data to a given CP worker to perform the operations related to configuring the corresponding DP resource(s) in accordance with the received requested state data. Each of the CP worker(s) 222 may execute an instance of resource manager 217. In some embodiments, resource manager 217 may be a managed service that automates deployment and management of DP resources. Resource manager 217 may include a declarative infrastructure provisioning tool (e.g., Terraform) to install, configure, and manage resources. In some embodiments, the resource manager 217 may provide service-specific orchestration operations. The CP worker(s) 222 may be communicatively coupled to any suitable number of services (e.g., cloud service(s) 214) including any suitable combination of a compute service, a storage service, etc.). In some embodiments, the CP worker(s) 222 may be configured to provide instructions to data plane (DP) resource manager 224 for configuring one or more DP resources. DP resource manager(s) 224 may be configured to create, modify, and/or remove or delete any suitable DP resource.

In some embodiments, DP resource manager(s) 224 may be configured to manage any suitable number of computing components (e.g., the DP resource(s) 204). The CP worker(s) 222 (e.g., via resource manager 217) may be configured to execute any suitable operations to cause the DP resource manager(s) 224 to execute any suitable operation on the DP resource(s) 204 in accordance with the instructions identified by workflow manager 220 to configure the DP resource(s) 204 in accordance with the requested state data. In some embodiments, CP monitoring service 218 may be communicatively coupled to DP resource(s) 204 and configured to monitor the health of DP resource(s) 204.

In some embodiments, the CP monitoring service 218 may be configured to monitor and assess current state data of the DP resource(s) 204. In some embodiments, the CP monitoring service 218 may receive current state data store/update current state data of the DP resource(s) 204 within CP data store 216. Current state data may be provided by DP resource manager(s) 224 to a corresponding CP worker, which in turn may provide the current state data to the control plane monitoring service 218 (directly or via workflow manager 220), which may then update the current state data for the DP resource within CP data store 216. In some embodiments, CP worker(s) 222 and/or workflow manager 220 may update CP data store 216 directly with the current state data of any suitable DP resource such that the current state data of a given DP resource may be retrieved by the CP monitoring service 218 at any suitable time. In some embodiments, resource manager 217 may be configured to provide generated and provide drift data (e.g., data indicating differences between the requested state data and current state data corresponding to the DP resource(s) 204) to drift management service 215. In some embodiments, resource manager 217 may provide the drift data corresponding to a deployment to the drift management service 215 prior to applying changes to the DP resource(s) 204 or subsequent to applying changes to the DP resource(s) 204. In some embodiments, drift management service 215 may be configured to determine whether to allow, reject, or remediate changes corresponding to DP resource(s) 204 based at least in part on contextual data (e.g., attribute/attributes values requested, attributes of the requesting entity, etc.).

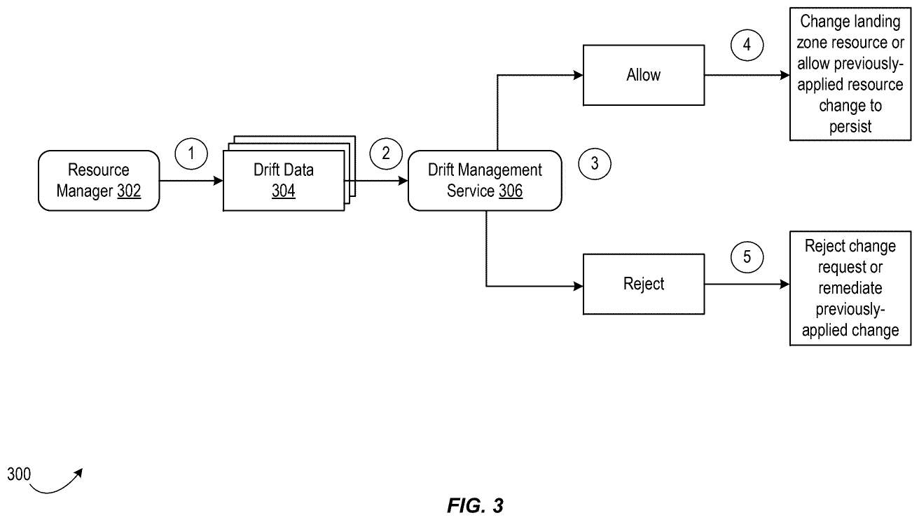

FIG. 3 is a block diagram depicting a method 300 for determining a remedial action corresponding to an intended or previously-applied change to a landing zone resource, according to at least one embodiment.

In some embodiments, method 300 may begin at step 1, where resource manager 302 (e.g., resource manager 217 of FIG. 2) may generate drift data 304. Drift data 304 may correspond to any suitable number of resources. In some embodiments, an instance of drift data 304 may correspond to any suitable number of resources deployed as a unit. By way of example, drift data 304 may include a deployment/stack which corresponds to a number of landing zone resources (e.g., shared compartment 126 of FIG. 1, hub-VCN 118, and/or any suitable infrastructure and/or software deployment of landing zone environment 102 of FIG. 1). deployed in accordance with a pre-defined template. The pre-defined template may include any suitable number of landing zone resources. As another example, drift data 304 may correspond to any suitable number of resources deployed by user request. In some embodiments, a user may request an “extension” which includes any suitable number of code segments that identify a desired state corresponding to any suitable number of resources (e.g., infrastructure and/or software resources). A single instance of drift data 304 may correspond to the resources associated with a pre-define template and/or one or more code segments that are deployed to the data plane 206 of FIG. 2 as a unit. In some embodiments, drift data 304 may indicate requested or previously-applied changes in a state of one or more resources. If user requested, contextual data (e.g., an identifier for the requesting user, a role of the requested user, and/or any suitable attribute associated with the resource(s) for which the change(s) are requested) may be included in the drift data 304 or provided with the drift data to drift management service 306 (e.g., drift management service 215 of FIG. 2) at step 2. In some embodiments, the drift management service 306 may obtain contextual data corresponding to the requested/previously-applied change from any suitable source (e.g., from the DP resource manager(s) 224 of FIG. 2), directly, or through any suitable intermediary component (e.g., CP worker(s) 222). In some embodiments, contextual data identifying a previously-applied change may be obtained from the resource manager 302 (e.g., resource manager 217, which in turn may have obtained such data from DP resource manager(s) 224).

At step 3, drift management service 306 may determine whether to allow or reject the changes indicated by the drift data 304. In embodiments in which drift data 304 corresponds to a requested change to a pre-existing resource, the drift management service 306 may obtain contextual data associated with the request. In some embodiments, the contextual data may be provided with the drift data 304. In some embodiments, the contextual data may be obtained by the drift management service 306 from any suitable component (e.g., by request to the resource manager 302, from CP data store 212 of FIG. 1, or the like). Contextual data may indicate the entity (e.g., an identifier corresponding to the user 208 of FIG. 2 indicating a user request, an identifier of a code segment corresponding to a resource, an identifier of a resource, etc., an identifier corresponding to the resource manager 302, etc.) with which the requested change to the pre-existing resources relates. In some embodiments, drift management service 306 may be configured with one or more policies that indicates which entities are allowed to or restricted from modifying particular resources. These policies may express attributes of an entity and/or attributed of a resource with an indication that a corresponding change is to be allowed/rejected. The drift management service 306 may compare attributes of the entity and/or resources to which the requested change relates to these policies to determine a match and a decision such as to allow or reject the requested change.

In embodiments in which drift data 304 corresponds to a previously-applied change resource, the drift management service 306 may obtain contextual data corresponding to the change. In some embodiments, the contextual data may be obtained from the resource manager 302 and/or the CP data store 212 of FIG. 2. The resource manager 302 may be configured to collect contextual data from DP manager(s) 224 of FIG. 2. Each of DP manager(s) 224 may correspond to one or more particular types of resources. As a non-limiting example, a DP manager of the DP manager(s) 224 may be a block storage volume service that is configured to manage block storage volumes within data plane 206. As another example, a DP manager of the DP manager(s) 224 may be a compute service that is configured to manage compute instances within data plane 206. As yet another example, a DP manager of the DP manager(s) 224 may be a network service that is configured to manage virtual cloud network components within data plane 206. The DP manager(s) 224 may provide actual state data of any suitable number of resources that each are individually configured to manage. In some embodiments, the resource manager 302 may be configured to detect the change to a given resource based at least in part on comparing the actual state of the resource and the last known state of the resource (as identified from current state data stored in CP data store 212). If a difference is identified between the actual state data provided by the DP manager(s) 224 and the current state data (e.g., the last known state of the resource(s)), resource manager 302 may generate drift data 304 to indicate the difference. In some embodiments, the resource manager 302 may request (e.g., from the DP manager(s) 224) contextual data that indicates (e.g., by identifier) which entity was responsible for the most-recent change to any suitable resource. The resource manager 302 may request additional user/entity data (e.g., from an identity service, one of cloud service(s) 214 of FIG. 2) that may include any suitable attribute that is associated with the user/entity and may include this user/entity data as part of the contextual data provided with the drift data 304. As another example, the drift management service 306 may obtain the contextual data, including the user/entity data, from the resource manager 302 or from any suitable source (e.g., from the identity service and/or any suitable service of cloud service(s) 214).

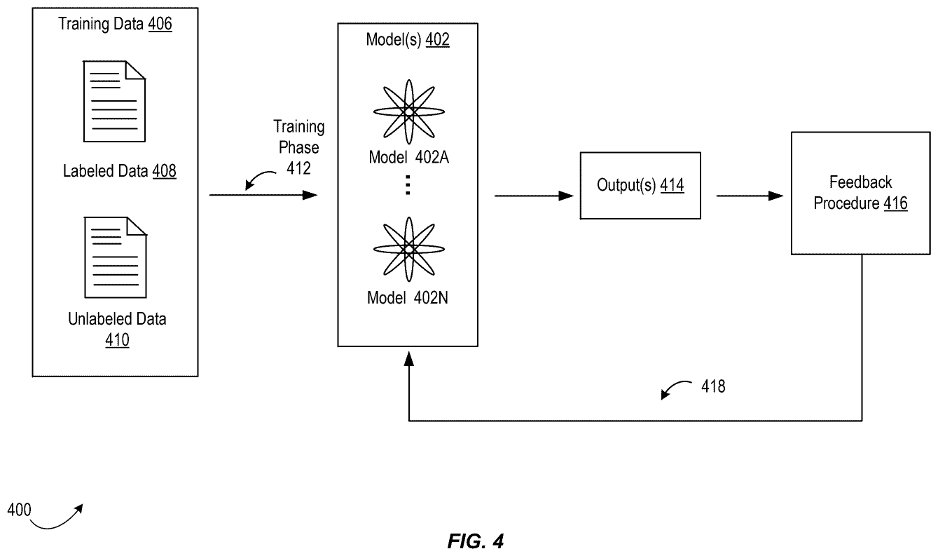

In some embodiments, the drift management service 306 may utilize previously-stored policies to determine whether to allow or reject a change (e.g., a requested change, a previously-applied change). This may include comparing attribute/attribute values of the entity requesting the change and/or attribute/attribute values of the resource(s) for which the change is requested to the attribute/attribute values of the entity and/or resource of a given policy. When a match is identified, the outcome specified by the policy (e.g., allow, reject, etc.) may be utilized as the determination of whether to allow or reject the change. In some embodiments, the drift management service 306 may utilize one or more machine-learning models to determine whether to allow or reject a change (e.g., a requested change, a previously-applied change, etc.). In some embodiments, the contextual data such as any suitable attribute/attribute value corresponding to the entity requesting the change, any suitable attribute/attribute value associated with the resource(s) for which the change is requested or was previously-applied, the attribute/attribute values of the requested/previously applied change, or the like may be provided as input to the machine-learning model(s). The machine-learning model(s) may be configured to provide an output corresponding to the input data. The output may indicate a decision of whether to allow or reject the change. A method for training these model(s) is discussed in further detail with respect to FIG. 4 and is not repeated here, for brevity.

In some embodiments, the drift management service 306 may maintain an approved state of each data plane resource (e.g., DP resource(s) 204 if FIG. 2). When an initial deployment of a resource is allowed/performed, the drift management service 306 may maintain approved state data that indicates the attributes/attribute values that correspond to the desired state data corresponding to the initial deployment of that resource. When user-requested changes are allowed, or previously-applied changes are allowed to persist, the drift management service 306 may update the approved state data for a given resource with the attribute values that were changed.

When the drift management service 306 determines that a requested change is to be allowed at step 3, it may send an indication and/or instructions to the resource manager 302 to effectuate the requested change and may update the approved state data with the attribute/attribute values corresponding to the requested change at step 4. When the drift management service 306 determines that a previously-applied change is to be allowed, the drift management service 306 may update the approved state data at step 4 with the attribute/attribute values corresponding to the resource as identified from the drift data 304.

When the drift management service 306 determines that a requested change is to be rejected, the drift management service 306 may transmit an indication of the rejection and/or instructions to resource manager 302 at step 5. Receiving this indication/instructions may cause the resource manager 302 to discard the corresponding change request or otherwise perform operations to cause the change request to be ignored/rejected. The drift management service 306 may refrain from updating the approved state data for the resource based at least in part on determining that the requested change is to be rejected. When the drift management service 306 determines that a previously-applied change is to be rejected, the drift management service 306 may transmit an indication of the rejection and/or instructions to resource manager 302 at step 5 to cause the resource manager 302 to remediate the previously-applied change. This may include transmitting the attribute/attribute values that were stored in the approved state data for that resource as maintained by the drift management service 306 at step 5. Receiving this indication/instructions may cause the resource manager 302 to execute operations that cause the current state of the resource to be changed to conform to the approved state data maintained by the drift management service 306.

FIG. 4 illustrates a flow depicting an example method 400 for training one or more machine-learning models, in accordance with at least one embodiment. In some embodiments, the model(s) 402 (e.g., model 402A, model 402B, etc.) may be trained (e.g., by the drift management service 215 of FIG. 2, or a different device or system) using any suitable machine-learning algorithms (e.g., supervised, unsupervised, etc.) and any suitable number of training data sets (e.g., training data 406). A supervised machine-learning algorithm refers to a machine learning task that includes learning an inferred function that maps an input to an output based on a labeled training data set for which example input/output pairs are known (e.g., labeled data 408). Unsupervised machine-learning algorithms refer to a set of algorithms that are used to analyze and cluster unlabeled data sets (e.g., unlabeled data 410). These algorithms are configured to identify patterns or data groupings without the need for human intervention. In some embodiments, any suitable number of model(s) 402 may be trained during training phase 412.

At least one model of model(s) may be trained (e.g., during training phase 412) to identify a decision (e.g., allow, reject, etc.) based at least in part on contextual data corresponding to resource drift (e.g., requested changes or previously-applied changes to a resource). Resource drift may be identified using a resource change request (e.g., user attributes/attribute values associated with a user that initiated the resource change request, resource attributes/attributes values of the resource for which the change is requested, current state data associated with the resource, requested/desired state data of the resource change request, etc.). As another example, resource drift may be identified based on detecting a difference between a current state of a resource and an approved state of the resource. The training data 406 for training one or more of model(s) 402 may include examples that may include contextual data for a requested change. In some embodiments, training data 406 may include examples (e.g., labeled data 408) that include a label that indicates whether a requested resource change was allowed or rejected. As another example, the training data 406 may include examples that may include contextual data (e.g., attributes/attributes values corresponding to the user or entity (e.g., Terraform module) that initiated the change, current and previous resource attribute value, one or more change policies associated with the user and/or entity, etc.) corresponding to previously-applied resource changes. In some embodiments, training data 406 may include examples (e.g., labeled data 408) that include a label that indicates whether the corresponding change was allowed to persist or remediated (e.g., reversed).

The model(s) 402 may include any suitable number of models that are trained using unsupervised learning techniques to identify a decision to allow or reject a requested resource change. As another example, the model(s) 402 may be trained using unsupervised learning techniques to determine whether to allow a previously-applied resource change to persist or to remediate the previously-applied resource change. Unsupervised machine-learning algorithms are configured to learn patterns from untagged data. In some embodiments, the training phase 412 may utilize unsupervised machine-learning algorithms to generate one or more of the model(s) 402. For example, the training data 406 may include unlabeled data 410 (e.g., any suitable data corresponding to a previous-applied resource change such as attributes/attribute values corresponding to the user or entity that initiated the change, change policies corresponding to the user/entity, current and/or approve state data of the resource, or the like). Unlabeled data 410 may be utilized, together with an unsupervised learning algorithm to segment the entries of unlabeled data 410 into groups. The unsupervised learning algorithm may be configured to cause similar entries to be grouped together in a common group. An example of an unsupervised learning algorithm may include clustering methods such as k-means clustering, DBScan, and the like. In some embodiments, the unlabeled data 410 may be clustered with the labeled data 408 such that unlabeled instances of a given group may be assigned the same labeled as other labeled instances within the group.

In some embodiments, any suitable portion of the training data 406 may be utilized during the training phase 412 to train the model(s) 402. For example, 70% of labeled data 408 and/or unlabeled data 410 may be utilized to train the model(s) 402. Once trained, or at any suitable time, the model(s) 402 may be evaluated as part of feedback procedure 416 to assess their quality (e.g., the accuracy of output(s) 414 with respect to the labels corresponding to labeled data 408). By way of example, a portion of the examples of labeled data 408 may be utilized as input to the model(s) 402 in order to generate output(s) 414. That is, an example of the labeled data 408 may be provided as input, and the corresponding output may be compared to the label from labeled data 408 that is associated with that example. If some portion of the output (e.g., a label) matches the example label of labeled data 408, that portion of the output may be deemed accurate. Any suitable number of labeled examples may be utilized, and a number of accurate labels may be compared to the total number of examples provided (and/or the total number of labels previously identified) to determine an accuracy value for a given model that quantifies a degree of accuracy for the model. For example, if 90 out of 100 of the input examples generate output labels that match the previously known example labels, the model being assessed may be determined to be 90% accurate. In some embodiments, feedback procedure 416 may include obtaining user feedback indicating whether the output(s) 414 were accurate. As another example, feedback procedure 416 may utilize any suitable metric to identify whether actions for allowing/rejecting a requested change or persisting/remediating a previously-applied change performed in accordance with output(s) 414 resulted in desired/undesired consequences.

In some embodiments, as the model(s) 402 are utilized for subsequent inputs, the subsequent output generated by the model(s) 402 may be added to corresponding input and used to retrain and/or update the model(s) 402 at 416. In some embodiments, the example may not be used to retrain or update the model until feedback procedure 416 is executed.

The training process depicted in FIG. 4 (e.g., method 400) may be performed any suitable number of times at any suitable interval and/or according to any suitable schedule such that the accuracy of the model(s) 402 are improved over time.

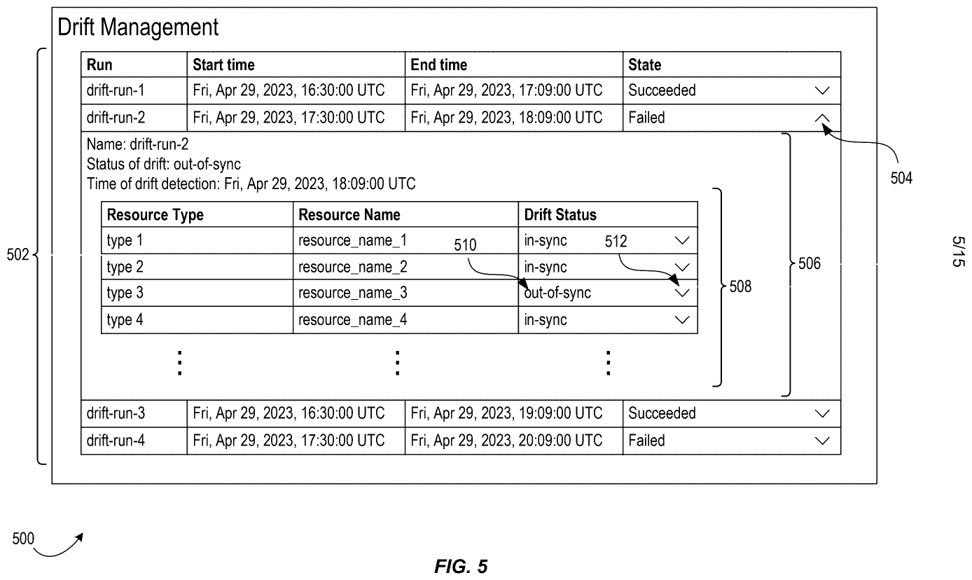

FIG. 5 is a schematic of an example user interface 500, according to at least one embodiment. User interface 500 may be configured to present drift data provided by a drift management service (e.g., drift management service 215 of FIG. 2, drift management service 306 of FIG. 3).

By way of example, user interface 500 presents drift data corresponding to any suitable number of drift data runs. In some embodiments, the drift management service may be configured to aggregate any suitable drift data instances (e.g., drift data 304 of FIG. 3) across any suitable number of resources/deployments as part of a drift data run. User interface 500 depicts four drift data runs (e.g., drift-run-1, drift-run-2, drift-run-3, drift-run-4) with area 502, although any suitable number of drift data runs may be presented at any suitable time. In some embodiments, as the example depicted in FIG. 5 suggests, a drift data run pay be performed hourly or according to any suitable periodicity or according to any suitable schedule.

User interface element 504 may be used to expand or contract area 506 within which drift data corresponding to drift-run-2 may be viewed. Each of the drift data run entries of area 502 may include a similar user interface element. When contracted, minimal data corresponding to a given drift data run may be presented (e.g., an identifier of the run (“drift-run-2”), a start timestamp corresponding to the start of the drift data run, an end timestamp corresponding to a time at which the drift data run was completed, and a state of resources that indicates whether all of the resources at the time of the drift run were determined to be in sync (“succeeded”) or out-of-sync (“failed”).

When expanded, area 506 may present any suitable data corresponding to a drift data run, including but not limited to attribute/attribute values corresponding to the drift data run (e.g., name, status of drift, time of drift detection/end time of the drift data run, etc.) and/or any suitable number of resources. In some embodiments, each resource existing in the environment (e.g., the landing zone environment 102 of FIG. 1) may be presented within area 508 (e.g., via a table or other suitable graphical element). As depicted in FIG. 5, area 508 may present a table in which four resources are visible. Area 508 may present any suitable number of resource attributes/attribute values (e.g., resource type, resource name, drift status, or the like). In some embodiments, the drift status of a given resource (e.g., the data presented at 510) may indicate whether the state of the resources was in-sync (e.g., matching the approved state of the resource as maintained by the drift management system) or out-of-sync (e.g., not matching the approved state of the resource as maintained by the drift management system. Additional data corresponding to a given resource may be presented or hidden from view based at least in part on a user interface element (e.g., the user interface element 512).

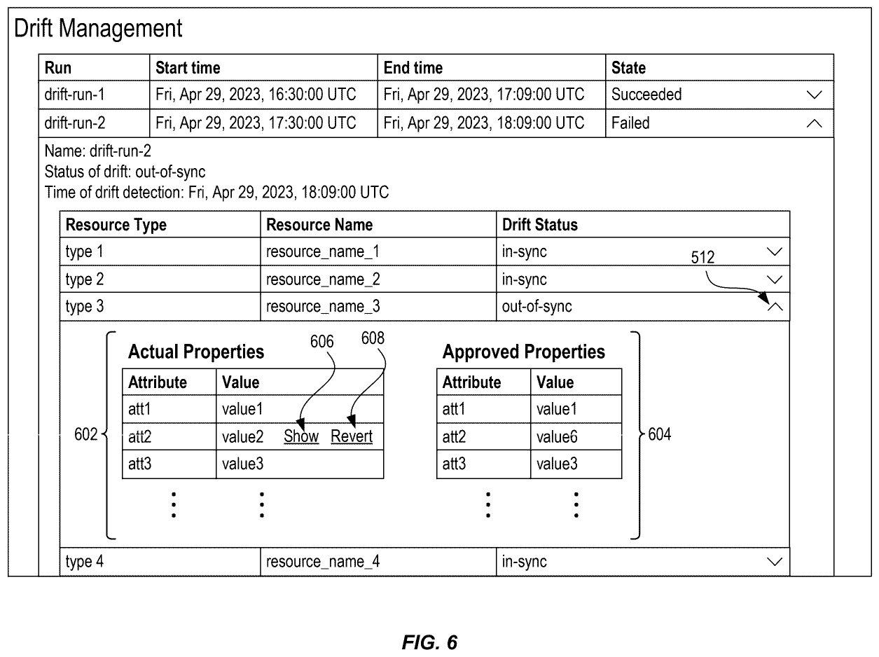

FIG. 6 is a schematic of another example user interface 600, according to at least one embodiment. User interface 600 may be configured to present drift data provided by a drift management service (e.g., drift management service 215 of FIG. 2, drift management service 306 of FIG. 3). User interface 600 is intended to depict a change to the user interface 500 of FIG. 5, when user interface element 512 has been selected.

Upon selecting user interface element 512, user interface 600 may be modified to present actual state data 602 and approved state data 604. In some embodiments, actual state data 602 may correspond to current state attribute/attribute values for the resource corresponding to user interface element 512 (e.g., “resource_name_3,” as depicted in FIG. 6, a data plane resource of DP resource(s) 204 of FIG. 2). Approved state data 604 may correspond to an approved state attribute/attribute values for the resource as maintained by the drift management service.

User interface 600 may be utilized in use cases in which resource drift is identified after the change to the resource has been made. In this use case, user interface 600 may present the user the ability to view the difference between the actual state of the resource and the approved state of the resource. In some embodiments, an option (e.g., option 606) may be presented for any attributes that are associated with a value that differs between the actual state data 602 and the approved state data 604. Upon selecting option 606, user interface 600 may be modified to present contextual data that indicates, among other things, an entity responsible for the actual/current attribute value for that resource. This may be the entity (e.g., a user, a code segment, a service, etc.) that was responsible for the actual/current attribute value assignment (or at least a last known change to the resource and/or attribute value). In some embodiments, any suitable data that is associated with the entity and/or the resource may be presented within user interface 600 upon selection of option 606.

In some embodiments, an option (e.g., option 608) may be presented for any attributes that are associated with a value that differs between the actual state data 602 and the approved state data 604. Upon selecting option 608, a request to revert/remediate the change that caused the difference in attribute values may be received by the drift management service. In some embodiments, the drift management service may be configured to execute any suitable operations to cause the attribute value for which option 608 was selected to be reverted, remediated, or otherwise changed to match the approved value of approved state data 604. In the example depicted in FIG. 6, selecting option 608 may cause the drift management service (e.g., the drift management service 215 of FIG. 2) to execute operations to cause the attribute “att2” to be reverted, remediated, or otherwise changed to “value6,” corresponding to the approved value for the attribute, as indicated in approved state data 604.

Using the user interfaces 600 enables the user to view previously-applied changes and manually allow the change to persist or cause the previously-applied change to be reverted/remediated. If allowed, the drift management service may execute operations to cause the change to persist and may update the approved state data for the resource to the value corresponding to the actual state data 602. If reverted, the drift management service may execute operations to cause an additional change to be executed to update the resource data to the value corresponding to the approved state data 604.

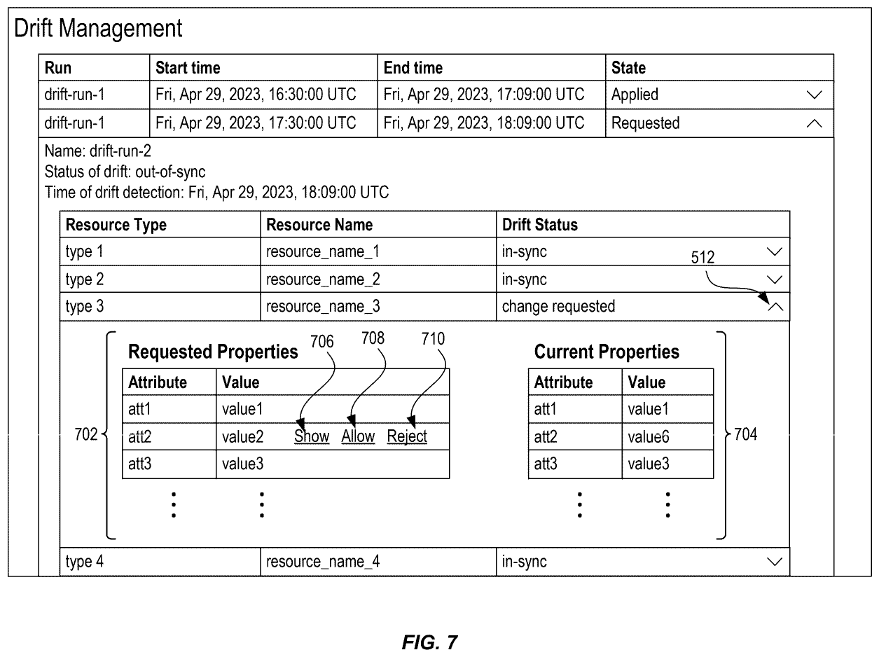

FIG. 7 is a schematic of yet another example user interface 700, according to at least one embodiment. User interface 700 may be configured to present drift data provided by a drift management service (e.g., drift management service 215 of FIG. 2, drift management service 306 of FIG. 3). User interface 700 is intended to depict another example of a change to the user interface 500 of FIG. 5, when user interface element 512 has been selected.

Upon selecting user interface element 512, user interface 700 may be modified to present requested state data 702 and current state data 704. In some embodiments, requested state data 702 may correspond to change request that indicates a requested state attribute/attribute values for the resource corresponding to user interface element 512 (e.g., “resource_name_3,” as depicted in FIG. 7, a data plane resource of DP resource(s) 204 of FIG. 2). Current state data 704 may correspond to the current or approved state attribute/attribute values for the resource as maintained by the drift management service and/or as stored in CP data store 212 of FIG. 2.

User interface 700 may be utilized in use cases in which resource drift is identified after a change request is received, but before the requested change to the resource has been made. In this use case, user interface 700 may present the user the ability to view the difference between the requested state of the resource and the current/approved state of the resource. In some embodiments, an option (e.g., option 706) may be presented for any attributes that are associated with a value that differs between the requested state data 702 and the approved state data 704. Upon selecting option 706, user interface 700 may be modified to present contextual data that indicates, among other things, an entity associated with the requested change. This may be the entity (e.g., a user, a code segment, a service, etc.) that is requesting/attempting to effectuate the requested attribute value assignment. In some embodiments, any suitable data that is associated with the entity and/or the resource may be presented within user interface 700 upon selection of option 706.

In some embodiments, an option (e.g., option 708) may be presented for any attributes that are associated with a value that differs between the requested state data 702 and the approved state data 704. Upon selecting option 708, an indication to allow the change in the corresponding attribute of the resource may be received by the drift management service. In some embodiments, the drift management service may be configured to execute any suitable operations to cause the attribute value for which option 708 was selected to be changed to the value corresponding to the option 708. In the example depicted in FIG. 7, selecting option 708 may cause the drift management service (e.g., the drift management service 215 of FIG. 2) to execute operations to cause the attribute “att2” to be changed to “value2” corresponding to the requested value for that attribute, as indicated in requested state data 702.

In some embodiments, an option (e.g., option 710) may be presented for any attributes that are associated with a value that differs between the requested state data 702 and the approved state data 704. Upon selecting option 708, an indication to reject the requested change may be received by the drift management service. In some embodiments, the drift management service may be configured to execute any suitable operations to cause the attribute value for which option 710 was selected to be rejected. In the example depicted in FIG. 7, selecting option 710 may cause the drift management service (e.g., the drift management service 215 of FIG. 2) to execute operations to cause the attribute “att2” to remain associated with the value “value6” corresponding to the approved state of that attribute, as indicated in approved state data 704.

Using the user interfaces 700 enables the user to view requested changes and manually allow the change or reject the change. If allowed, the drift management service may execute operations to cause the change to be effectuated (e.g., by the resource manager 217 of FIG. 2) and may update the approved state data for the resource to the value corresponding to the approved state data 704. If rejected, the drift management service may execute operations to cause the requested change to be discarded or otherwise ignored. In this case, the attribute value of the approved state data 704 may remain unchanged.

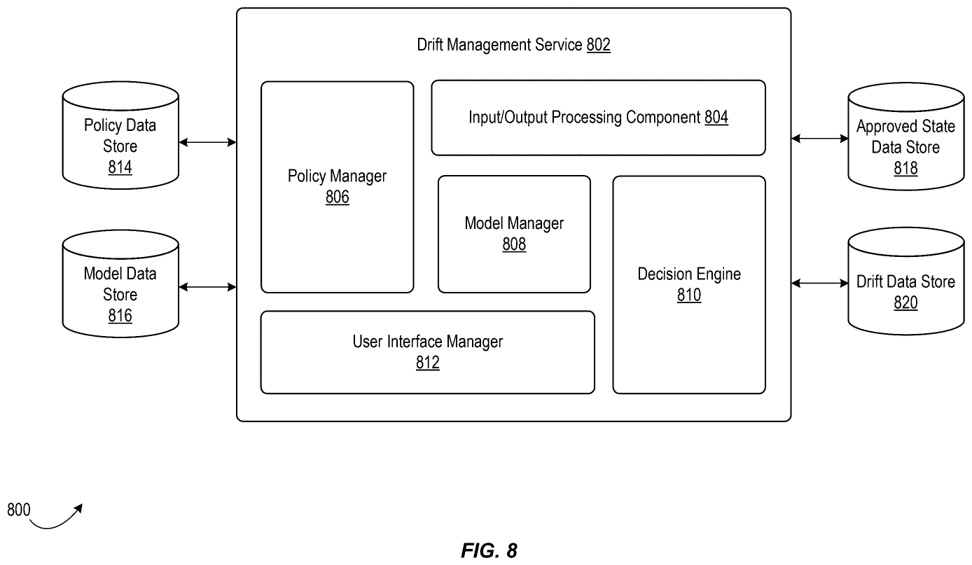

FIG. 8 illustrates an example computer architecture 800 for a drift management service, according to at least one embodiment. The drift management service 802 (e.g., the drift management service 215 of FIG. 2, the drift management service 306 of FIG. 3, etc.) may include input/output processing component 804 which may be configured to receive and/or transmit any suitable data between the drift management service 802 and any suitable device/component of FIG. 2 (e.g., the resource manager 217, other services of cloud service(s) 215, the CP data store 212, or the like). As depicted, the drift management service 802 may include a policy manager 806, a model manager 808, a decision engine 810, and a user interface manager 812, although more or fewer computing components or subroutines may be similarly utilized. The drift management service 802 may communicate with policy data store 814, model data store 816, approved state data 818, and drift data store 820, although data may be stored in more or fewer data stores than the number depicted in FIG. 8.

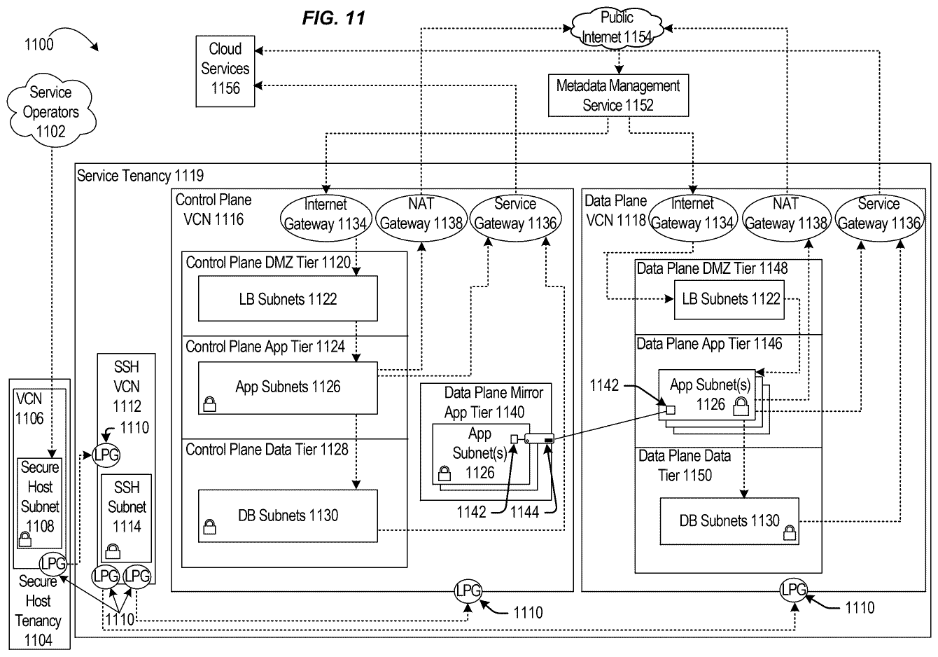

The functionality described in connection with drift management service 802 may, in some embodiments, be executed by one or more virtual machines that are implemented in a hosted computing environment (e.g., a cloud computing environment such as the one depicted in FIG. 2). The hosted computing environment may include one or more rapidly provisioned and released computing resources, which computing resources may include computing, networking and/or storage devices. A hosted computing environment may also be referred to as a cloud-computing environment. A number of example cloud-computing environments are provided and discussed below in more detail with respect to FIGS. 11-15.

In some embodiments, the input/output processing component 804 may be configured to receive, obtain, provide, or transmit any suitable data to/from the components of FIG. 2 or any suitable combination of the data stores depicted in FIG. 8. The input/output processing component 804 may receive drift data (e.g., drift data 304) and store this drift data in drift data store 820, a data store configured to store such information. Drift data store 820 (and any suitable combination of the data stores of FIG. 8) may be provided in local or remote storage. In some embodiments, any suitable data store of FIG. 8 may be provided as cloud storage within a cloud-computing environment. Input/output processing component 804 may be configured to receive policy data and store these policies within policy data store 814. In some embodiments, input/output processing component 804 may be configured to receive training data (e.g., any suitable portion of training data 406 of FIG. 4) corresponding to one or more machine-learning models (e.g., model(s) 402 of FIG. 4) and may store this data in model data store 816. In some embodiments, the input/output processing component 804 may be configured to aggregate any suitable number of drift data instances (e.g., drift data 304 of a given drift data run). Aggregated drift data may be stored in drift data store 820.

In some embodiments, the user interface manager 812 may be configured to provide any suitable user interfaces (e.g., user interfaces 500-700 of FIGS. 5-7) to present any suitable data including, but not limited to, policies for determining whether to allow/reject/revert requested and/or previously-applied resource changes, current state data for any suitable number of resources, approved state data for any suitable number of resources, drift data corresponding to any suitable number of drift runs, or the like. In some embodiments, the user interface manager 812 may be configured to obtain any suitable user input such as one or more policies for determining whether to allow/reject/revert a resource change and/or user input such as selection of the user interface elements and/or options depicted in user interfaces 500-700.

In some embodiments, model manager 808 may be configured to utilize the training data of model data store 816 to train one or more models (e.g., model(s) 402). In some embodiments, the model manager 808 may utilize the method 400 of FIG. 4 to train the model(s). Any suitable data (e.g., model hyperparameters, or the like) of the trained model may be stored within model data store 816 by model manager 808. Model manager 808 may be configured to receive input data (e.g., from decision engine 810) from any suitable source (e.g., the decision engine 810), provide the input data to the trained model(s), and transmit or otherwise communicate output data generated by the model(s) to any suitable destination (e.g., decision engine 810).

In some embodiments, the functionality of decision engine 810 may be invoked based at least in part on receiving drift data (e.g., drift data 304) and/or by user input. The decision engine 810 may be configured to determine whether the allow or reject a requested and/or previously-applied change. In some embodiments, the decision engine 810 may execute method 300 of FIG. 3. The decision engine 810 may be configured to maintain approved state data within approved state data store 818 for any suitable number of resources and may update the approved state data in the manner discussed in the above figures.

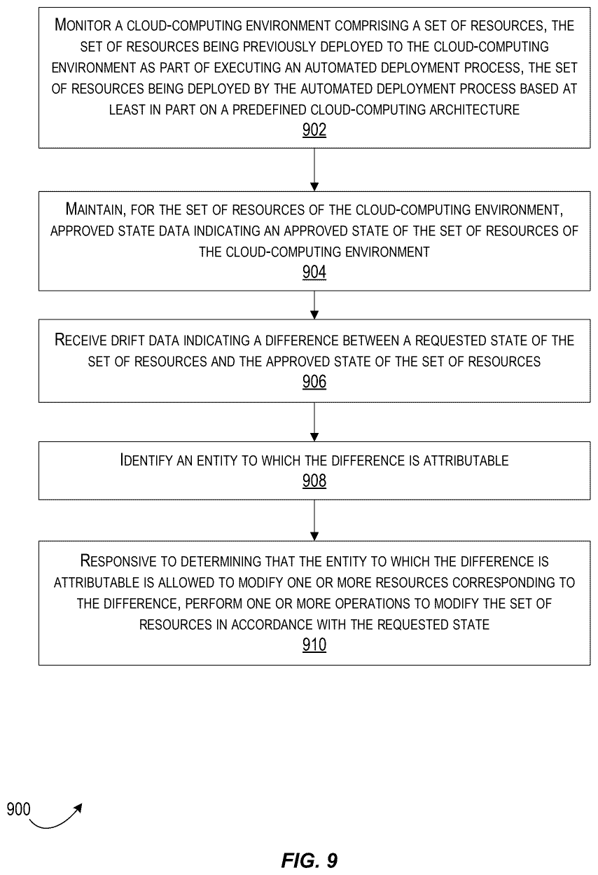

FIG. 9 is a block diagram illustrating an example method 1000 for detecting and responding to requested resource changes, according to at least one embodiment. The method 1000 may be performed by drift management service 802 of FIG. 8. The drift management service 802 may be executed by a computing device comprising one or more processors and one or more memories that store computer-executable instructions that, when executed by the one or more processors, cause the one or more processors to perform the steps/operations of method 900. In some embodiments, the method 900 may include more or fewer steps than the number depicted in FIG. 9. It should be appreciated that the steps of method 900 may be performed in any suitable order.

Method 900 may begin at 902, where a cloud-computing environment (e.g., environment 100 of FIG. 1) comprising a set of resources may be monitored. In some embodiments, the set of resources may be previously deployed to the cloud-computing environment as part of executing an automated deployment process (e.g., as part of an automated deployment of a landing zone environment). In some embodiments, the set of resources may be deployed by the automated deployment process based at least in part on a predefined cloud-computing architecture (e.g., in accordance with an architecture specified in a predefined template that includes code segments (e.g., Terraform code segments) that indicate a desired state of the corresponding resource(s)).

At 904, approved state data indicating an approved state of the set of resources of the cloud-computing environment (e.g., approved state data 704 of FIG. 7) may be maintained for the set of resources of the cloud-computing environment (e.g., the resources depicted in landing zone environment 102 of FIG. 1).

At 906, drift data (e.g., drift data 304 of FIG. 3) indicating a difference between a requested state of the set of resources (e.g., requested state data 702 of FIG. 7) and the approved state of the set of resources (e.g., approved state data 704 of FIG. 7) may be received (or obtained) (e.g., from resource manager 217 of FIG. 2, from CP data store 212 of FIG. 2, etc.).

At 908, an entity to which the difference is attributable may be identified. By way of example, the drift management service may receive/obtain contextual data corresponding to a change request that indicated the requested resource change. In some embodiments, the contextual data may be provided with the drift data, or the contextual data may be obtained from any suitable component (e.g., the resource manager 217, the DP resource manager(s) 224, the CP data store 212, or the like). In some embodiments, the change request may include an identifier for the entity. The identifier may be utilized to obtain any suitable attribute that is associated with the entity from any suitable computing component (e.g., from an identity service of cloud service(s) 214 of FIG. 2).

At 910, responsive to determining that the entity to which the difference is attributable is allowed to modify one or more resources corresponding to the difference, one or more operations to modify the set of resources in accordance with the requested state may be performed. In some embodiments, the method 300 of FIG. 3 may be executed to determine whether to allow or reject the requested change. If allowed, operations may be executed to cause the change to be effectuated. If rejected, operations may be executed to cause the change request to be discarded or otherwise ignored.

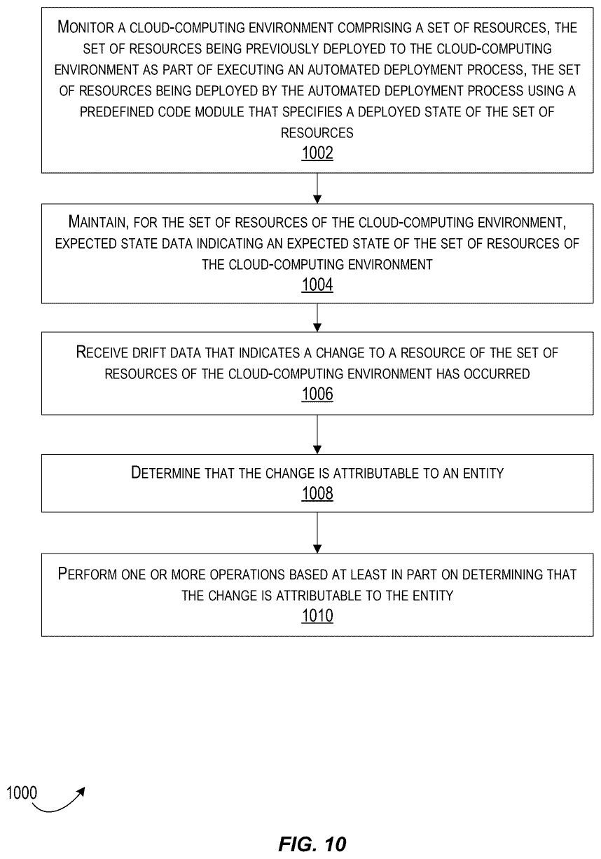

FIG. 10 is a block diagram illustrating an example method 1000 for detecting and responding to resource drift, according to at least one embodiment. The method 1000 may be performed by drift management service 802 of FIG. 8. The drift management service 802 may be executed by a computing device comprising one or more processors and one or more memories that store computer-executable instructions that, when executed by the one or more processors, cause the one or more processors to perform the steps/operations of method 1000. In some embodiments, the method 1000 may include more or fewer steps than the number depicted in FIG. 10. It should be appreciated that the steps of method 1000 may be performed in any suitable order.

Method 1000 may begin at 1002, where a cloud-computing environment comprising a set of resources may be monitored. In some embodiments, the set of resources may be previously deployed to the cloud-computing environment as part of executing an automated deployment process. In some embodiments, the set of resources may be deployed by the automated deployment process using a predefined code module that specifies a deployed state of the set of resources.

At 1004, expected state data (e.g., approved state data 604 of FIG. 6) indicating an expected state (also referred to as an approved state) of the set of resources of the cloud-computing environment may be maintained for the set of resources of the cloud-computing environment.

At 1006, drift data (e.g., drift data 304 of FIG. 3) may be received or obtained (e.g., from resource manager 217 of FIG. 2, from CP data store 212 of FIG. 2, from DP resource manager(s) 224 of FIG. 2, etc.) that indicates a change to a resource of the set of resources of the cloud-computing environment has occurred.

At 1008, the drift management service may determine that the change is attributable to an entity. By way of example, the drift management service may receive/obtain contextual data corresponding to the change indicated by the drift data. In some embodiments, the contextual data may be provided with the drift data, or the contextual data may be obtained from any suitable component (e.g., the resource manager 217, the DP resource manager(s) 224, the CP data store 212, or the like). In some embodiments, the contextual data may include an identifier for the entity responsible for the change (or at least a last known change to a given resource). The identifier may be utilized to obtain any suitable attribute that is associated with the entity from any suitable computing component (e.g., from an identity service of cloud service(s) 214 of FIG. 2).

At 1010, one or more operations may be performed based at least in part on determining that the change is attributable to the entity. In some embodiments, the method 300 of FIG. 3 may be executed to determine whether to allow a previously-applied change to persist or to reject/revert/remediate the previously-applied change to a last approved value (e.g., a value corresponding to the approved state data for a given resource). If allowed, operations may be executed to cause the change to persist. If rejected, operations may be executed to cause the attribute value of the resource to be modified to match the corresponding attribute value of approved state data that is associated with the resource.

### Example IaaS Environments

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 11 is a block diagram 1100 illustrating an example pattern of an IaaS architecture, according to at least one embodiment. Service operators 1102 can be communicatively coupled to a secure host tenancy 1104 that can include a virtual cloud network (VCN) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (LPG) 1110 that can be communicatively coupled to a secure shell (SSH) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (DMZ) tier 1120 that acts as a perimeter network (e.g., portions of a corporate network between the corporate intranet and external networks). The DMZ-based servers may have restricted responsibilities and help keep breaches contained. Additionally, the DMZ tier 1120 can include one or more load balancer (LB) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively coupled to cloud services 1156.

In some examples, the service gateway 1136 of the control plane VCN 1116 or of the data plane VCN 1118 can make application programming interface (API) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (CRUD) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Metadata that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users', or other customers', resources. Also, this embodiment may allow users or customers of the system to store databases privately without needing to rely on public Internet 1154, which may not have a desired level of threat prevention, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the IaaS provider and may be stored on the service tenancy 1119, which may be isolated from public Internet 1154.

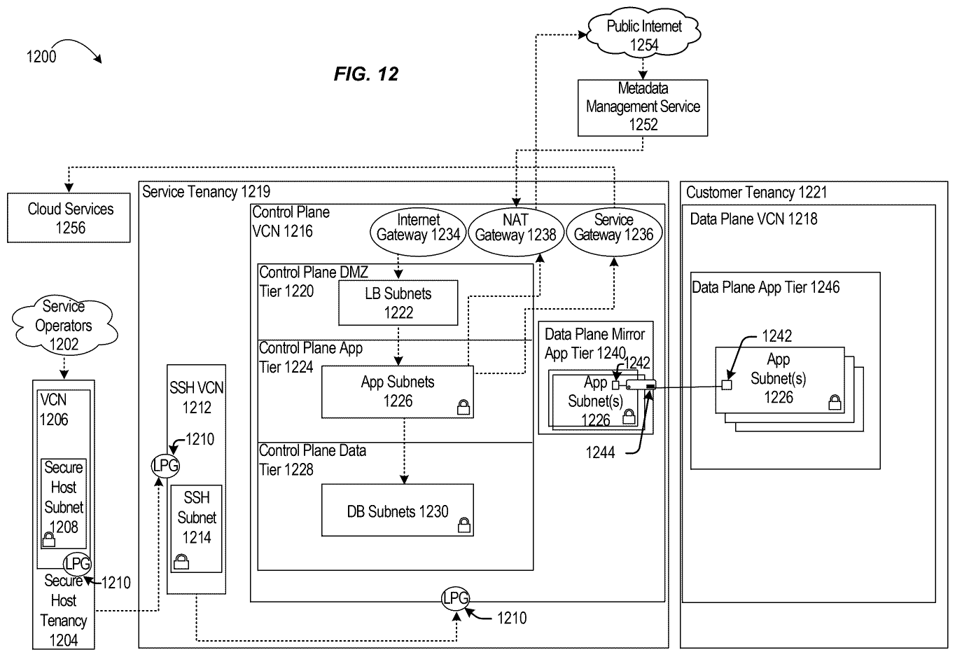

FIG. 12 is a block diagram 1200 illustrating another example pattern of an IaaS architecture, according to at least one embodiment. Service operators 1202 (e.g., service operators 1102 of FIG. 11) can be communicatively coupled to a secure host tenancy 1204 (e.g., the secure host tenancy 1104 of FIG. 11) that can include a virtual cloud network (VCN) 1206 (e.g., the VCN 1106 of FIG. 11) and a secure host subnet 1208 (e.g., the secure host subnet 1108 of FIG. 11). The VCN 1206 can include a local peering gateway (LPG) 1210 (e.g., the LPG 1110 of FIG. 11) that can be communicatively coupled to a secure shell (SSH) VCN 1212 (e.g., the SSH VCN 1112 of FIG. 11) via an LPG 1110 contained in the SSH VCN 1212. The SSH VCN 1212 can include an SSH subnet 1214 (e.g., the SSH subnet 1114 of FIG. 11), and the SSH VCN 1212 can be communicatively coupled to a control plane VCN 1216 (e.g., the control plane VCN 1116 of FIG. 11) via an LPG 1210 contained in the control plane VCN 1216. The control plane VCN 1216 can be contained in a service tenancy 1219 (e.g., the service tenancy 1119 of FIG. 11), and the data plane VCN 1218 (e.g., the data plane VCN 1118 of FIG. 11) can be contained in a customer tenancy 1221 that may be owned or operated by users, or customers, of the system.

The control plane VCN 1216 can include a control plane DMZ tier 1220 (e.g., the control plane DMZ tier 1120 of FIG. 11) that can include LB subnet(s) 1222 (e.g., LB subnet(s) 1122 of FIG. 11), a control plane app tier 1224 (e.g., the control plane app tier 1124 of FIG. 11) that can include app subnet(s) 1226 (e.g., app subnet(s) 1126 of FIG. 11), a control plane data tier 1228 (e.g., the control plane data tier 1128 of FIG. 11) that can include database (DB) subnet(s) 1230 (e.g., similar to DB subnet(s) 1130 of FIG. 11). The LB subnet(s) 1222 contained in the control plane DMZ tier 1220 can be communicatively coupled to the app subnet(s) 1226 contained in the control plane app tier 1224 and an Internet gateway 1234 (e.g., the Internet gateway 1134 of FIG. 11) that can be contained in the control plane VCN 1216, and the app subnet(s) 1226 can be communicatively coupled to the DB subnet(s) 1230 contained in the control plane data tier 1228 and a service gateway 1236 (e.g., the service gateway 1136 of FIG. 11) and a network address translation (NAT) gateway 1238 (e.g., the NAT gateway 1138 of FIG. 11). The control plane VCN 1216 can include the service gateway 1236 and the NAT gateway 1238.

The control plane VCN 1216 can include a data plane mirror app tier 1240 (e.g., the data plane mirror app tier 1140 of FIG. 11) that can include app subnet(s) 1226. The app subnet(s) 1226 contained in the data plane mirror app tier 1240 can include a virtual network interface controller (VNIC) 1242 (e.g., the VNIC of 1142) that can execute a compute instance 1244 (e.g., similar to the compute instance 1144 of FIG. 11). The compute instance 1244 can facilitate communication between the app subnet(s) 1226 of the data plane mirror app tier 1240 and the app subnet(s) 1226 that can be contained in a data plane app tier 1246 (e.g., the data plane app tier 1146 of FIG. 11) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g., the metadata management service 1152 of FIG. 11) that can be communicatively coupled to public Internet 1254 (e.g., public Internet 1154 of FIG. 11). Public Internet 1254 can be communicatively coupled to the NAT gateway 1238 contained in the control plane VCN 1216. The service gateway 1236 contained in the control plane VCN 1216 can be communicatively coupled to cloud services 1256 (e.g., cloud services 1156 of FIG. 11).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources, that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218 but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may be isolated from cloud services 1256 that may not be in the same region as the control plane VCN 1216. For example, the control plane VCN 1216 may be located in “Region 1,” and cloud service “Deployment 11,” may be located in Region 1 and in “Region 2.” If a call to Deployment 11 is made by the service gateway 1236 contained in the control plane VCN 1216 located in Region 1, the call may be transmitted to Deployment 11 in Region 1. In this example, the control plane VCN 1216, or Deployment 11 in Region 1, may not be communicatively coupled to, or otherwise in communication with, Deployment 11 in Region 2.

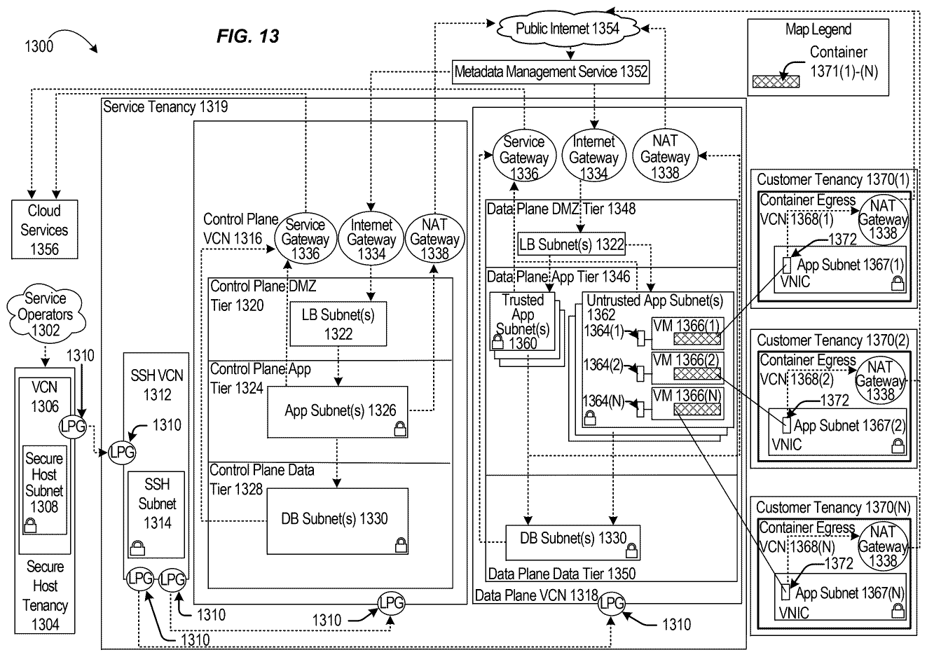

FIG. 13 is a block diagram 1300 illustrating another example pattern of an IaaS architecture, according to at least one embodiment. Service operators 1302 (e.g., service operators 1102 of FIG. 11) can be communicatively coupled to a secure host tenancy 1304 (e.g., the secure host tenancy 1104 of FIG. 11) that can include a virtual cloud network (VCN) 1306 (e.g., the VCN 1106 of FIG. 11) and a secure host subnet 1308 (e.g., the secure host subnet 1108 of FIG. 11). The VCN 1306 can include an LPG 1310 (e.g., the LPG 1110 of FIG. 11) that can be communicatively coupled to an SSH VCN 1312 (e.g., the SSH VCN 1112 of FIG. 11) via an LPG 1310 contained in the SSH VCN 1312. The SSH VCN 1312 can include an SSH subnet 1314 (e.g., the SSH subnet 1114 of FIG. 11), and the SSH VCN 1312 can be communicatively coupled to a control plane VCN 1316 (e.g., the control plane VCN 1116 of FIG. 11) via an LPG 1310 contained in the control plane VCN 1316 and to a data plane VCN 1318 (e.g., the data plane 1118 of FIG. 11) via an LPG 1310 contained in the data plane VCN 1318. The control plane VCN 1316 and the data plane VCN 1318 can be contained in a service tenancy 1319 (e.g., the service tenancy 1119 of FIG. 11).

The control plane VCN 1316 can include a control plane DMZ tier 1320 (e.g., the control plane DMZ tier 1120 of FIG. 11) that can include load balancer (LB) subnet(s) 1322 (e.g., LB subnet(s) 1122 of FIG. 11), a control plane app tier 1324 (e.g., the control plane app tier 1124 of FIG. 11) that can include app subnet(s) 1326 (e.g., similar to app subnet(s) 1126 of FIG. 11), a control plane data tier 1328 (e.g., the control plane data tier 1128 of FIG. 11) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g., the Internet gateway 1134 of FIG. 11) that can be contained in the control plane VCN 1316, and the app subnet(s) 1326 can be communicatively coupled to the DB subnet(s) 1330 contained in the control plane data tier 1328 and to a service gateway 1336 (e.g., the service gateway of FIG. 11) and a network address translation (NAT) gateway 1338 (e.g., the NAT gateway 1138 of FIG. 11). The control plane VCN 1316 can include the service gateway 1336 and the NAT gateway 1338.

The data plane VCN 1318 can include a data plane app tier 1346 (e.g., the data plane app tier 1146 of FIG. 11), a data plane DMZ tier 1348 (e.g., the data plane DMZ tier 1148 of FIG. 11), and a data plane data tier 1350 (e.g., the data plane data tier 1150 of FIG. 11). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364(1)-(N) that can be communicatively coupled to tenant virtual machines (VMs) 1366(1)-(N). Each tenant VM 1366(1)-(N) can be communicatively coupled to a respective app subnet 1367(1)-(N) that can be contained in respective container egress VCNs 1368(1)-(N) that can be contained in respective customer tenancies 1370(1)-(N). Respective secondary VNICs 1372(1)-(N) can facilitate communication between the untrusted app subnet(s) 1362 contained in the data plane VCN 1318 and the app subnet contained in the container egress VCNs 1368(1)-(N). Each container egress VCNs 1368(1)-(N) can include a NAT gateway 1338 that can be communicatively coupled to public Internet 1354 (e.g., public Internet 1154 of FIG. 11).

The Internet gateway 1334 contained in the control plane VCN 1316 and contained in the data plane VCN 1318 can be communicatively coupled to a metadata management service 1352 (e.g., the metadata management system 1152 of FIG. 11) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively coupled to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1346. Code to run the function may be executed in the VMs 1366(1)-(N), and the code may not be configured to run anywhere else on the data plane VCN 1318. Each VM 1366(1)-(N) may be connected to one customer tenancy 1370. Respective containers 1371(1)-(N) contained in the VMs 1366(1)-(N) may be configured to run the code. In this case, there can be a dual isolation (e.g., the containers 1371(1)-(N) running code, where the containers 1371(1)-(N) may be contained in at least the VM 1366(1)-(N) that are contained in the untrusted app subnet(s) 1362), which may help prevent incorrect or otherwise undesirable code from damaging the network of the IaaS provider or from damaging a network of a different customer. The containers 1371(1)-(N) may be communicatively coupled to the customer tenancy 1370 and may be configured to transmit or receive data from the customer tenancy 1370. The containers 1371(1)-(N) may not be configured to transmit or receive data from any other entity in the data plane VCN 1318. Upon completion of running the code, the IaaS provider may kill or otherwise dispose of the containers 1371(1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371(1)-(N) that can be contained in the VM 1366(1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 1316 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336. For example, a call to cloud services 1356 from the control plane VCN 1316 can include a request for a service that can communicate with the data plane VCN 1318.

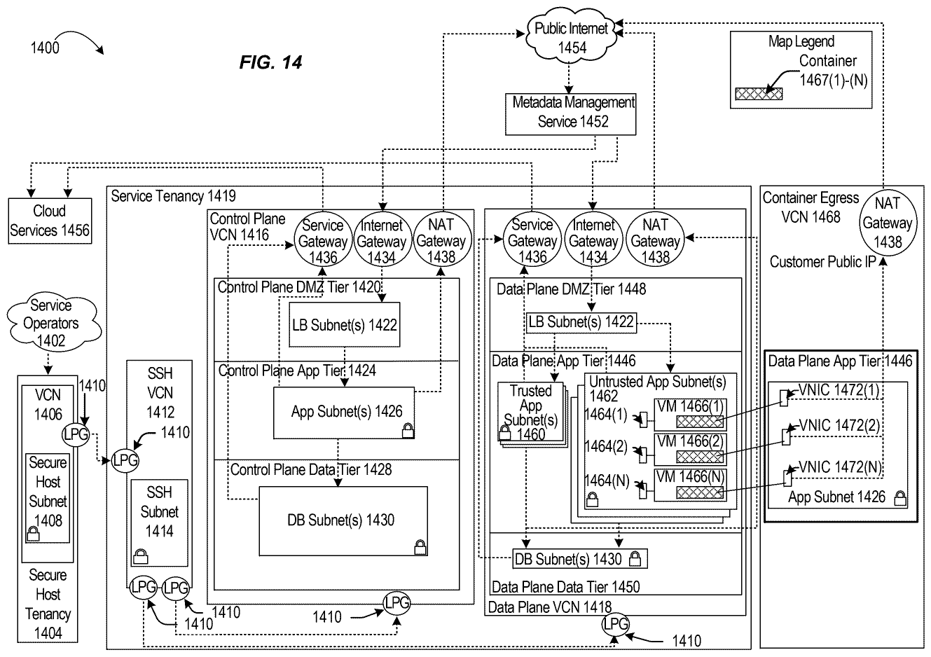

FIG. 14 is a block diagram 1400 illustrating another example pattern of an IaaS architecture, according to at least one embodiment. Service operators 1402 (e.g., service operators 1102 of FIG. 11) can be communicatively coupled to a secure host tenancy 1404 (e.g., the secure host tenancy 1104 of FIG. 11) that can include a virtual cloud network (VCN) 1406 (e.g., the VCN 1106 of FIG. 11) and a secure host subnet 1408 (e.g., the secure host subnet 1108 of FIG. 11). The VCN 1406 can include an LPG 1410 (e.g., the LPG 1110 of FIG. 11) that can be communicatively coupled to an SSH VCN 1412 (e.g., the SSH VCN 1112 of FIG. 11) via an LPG 1410 contained in the SSH VCN 1412. The SSH VCN 1412 can include an SSH subnet 1414 (e.g., the SSH subnet 1114 of FIG. 11), and the SSH VCN 1412 can be communicatively coupled to a control plane VCN 1416 (e.g., the control plane VCN 1116 of FIG. 11) via an LPG 1410 contained in the control plane VCN 1416 and to a data plane VCN 1418 (e.g., the data plane 1118 of FIG. 11) via an LPG 1410 contained in the data plane VCN 1418. The control plane VCN 1416 and the data plane VCN 1418 can be contained in a service tenancy 1419 (e.g., the service tenancy 1119 of FIG. 11).

The control plane VCN 1416 can include a control plane DMZ tier 1420 (e.g., the control plane DMZ tier 1120 of FIG. 11) that can include LB subnet(s) 1422 (e.g., LB subnet(s) 1122 of FIG. 11), a control plane app tier 1424 (e.g., the control plane app tier 1124 of FIG. 11) that can include app subnet(s) 1426 (e.g., app subnet(s) 1126 of FIG. 11), a control plane data tier 1428 (e.g., the control plane data tier 1128 of FIG. 11) that can include DB subnet(s) 1430 (e.g., DB subnet(s) 1330 of FIG. 13). The LB subnet(s) 1422 contained in the control plane DMZ tier 1420 can be communicatively coupled to the app subnet(s) 1426 contained in the control plane app tier 1424 and to an Internet gateway 1434 (e.g., the Internet gateway 1134 of FIG. 11) that can be contained in the control plane VCN 1416, and the app subnet(s) 1426 can be communicatively coupled to the DB subnet(s) 1430 contained in the control plane data tier 1428 and to a service gateway 1436 (e.g., the service gateway of FIG. 11) and a network address translation (NAT) gateway 1438 (e.g., the NAT gateway 1138 of FIG. 11). The control plane VCN 1416 can include the service gateway 1436 and the NAT gateway 1438.

The data plane VCN 1418 can include a data plane app tier 1446 (e.g., the data plane app tier 1146 of FIG. 11), a data plane DMZ tier 1448 (e.g., the data plane DMZ tier 1148 of FIG. 11), and a data plane data tier 1450 (e.g., the data plane data tier 1150 of FIG. 11). The data plane DMZ tier 1448 can include LB subnet(s) 1422 that can be communicatively coupled to trusted app subnet(s) 1460 (e.g., trusted app subnet(s) 1360 of FIG. 13) and untrusted app subnet(s) 1462 (e.g., untrusted app subnet(s) 1362 of FIG. 13) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464(1)-(N) that can be communicatively coupled to tenant virtual machines (VMs) 1466(1)-(N) residing within the untrusted app subnet(s) 1462. Each tenant VM 1466(1)-(N) can run code in a respective container 1467(1)-(N) and be communicatively coupled to an app subnet 1426 that can be contained in a data plane app tier 1446 that can be contained in a container egress VCN 1468. Respective secondary VNICs 1472(1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g., public Internet 1154 of FIG. 11).

The Internet gateway 1434 contained in the control plane VCN 1416 and contained in the data plane VCN 1418 can be communicatively coupled to a metadata management service 1452 (e.g., the metadata management system 1152 of FIG. 11) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively coupled to cloud services 1456.

In some examples, the pattern illustrated by the architecture of block diagram 1400 of FIG. 14 may be considered an exception to the pattern illustrated by the architecture of block diagram 1300 of FIG. 13 and may be desirable for a customer of the IaaS provider if the IaaS provider cannot directly communicate with the customer (e.g., a disconnected region). The respective containers 1467(1)-(N) that are contained in the VMs 1466(1)-(N) for each customer can be accessed in real-time by the customer. The containers 1467(1)-(N) may be configured to make calls to respective secondary VNICs 1472(1)-(N) contained in app subnet(s) 1426 of the data plane app tier 1446 that can be contained in the container egress VCN 1468. The secondary VNICs 1472(1)-(N) can transmit the calls to the NAT gateway 1438 that may transmit the calls to public Internet 1454. In this example, the containers 1467(1)-(N) that can be accessed in real-time by the customer can be isolated from the control plane VCN 1416 and can be isolated from other entities contained in the data plane VCN 1418. The containers 1467(1)-(N) may also be isolated from resources from other customers.

In other examples, the customer can use the containers 1467(1)-(N) to call cloud services 1456. In this example, the customer may run code in the containers 1467(1)-(N) that requests a service from cloud services 1456. The containers 1467(1)-(N) can transmit this request to the secondary VNICs 1472(1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

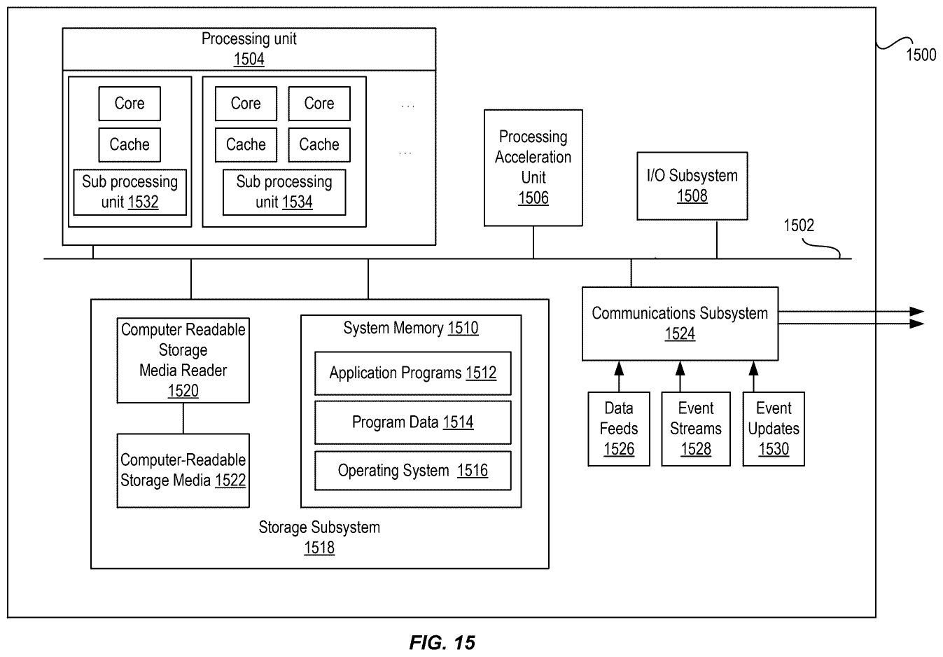

FIG. 15 illustrates an example computer system 1500, in which various embodiments may be implemented. The system 1500 may be used to implement any of the computer systems described above. As shown in the figure, computer system 1500 includes a processing unit 1504 that communicates with a number of peripheral subsystems via a bus subsystem 1502. These peripheral subsystems may include a processing acceleration unit 1506, an I/O subsystem 1508, a storage subsystem 1518 and a communications subsystem 1524. Storage subsystem 1518 includes tangible computer-readable storage media 1522 and a system memory 1510.

Bus subsystem 1502 provides a mechanism for letting the various components and subsystems of computer system 1500 communicate with each other as intended. Although bus subsystem 1502 is shown schematically as a single bus, alternative embodiments of the bus subsystem may utilize multiple buses. Bus subsystem 1502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1504, which can be implemented as one or more integrated circuits (e.g., a conventional microprocessor or microcontroller), controls the operation of computer system 1500. One or more processors may be included in processing unit 1504. These processors may include single core or multicore processors. In certain embodiments, processing unit 1504 may be implemented as one or more independent processing units 1532 and/or 1534 with single or multicore processors included in each processing unit. In other embodiments, processing unit 1504 may also be implemented as a quad-core processing unit formed by integrating two dual-core processors into a single chip.

In various embodiments, processing unit 1504 can execute a variety of programs in response to program code and can maintain multiple concurrently executing programs or processes. At any given time, some or all of the program code to be executed can be resident in processor(s) 1504 and/or in storage subsystem 1518. Through suitable programming, processor(s) 1504 can provide various functionalities described above. Computer system 1500 may additionally include a processing acceleration unit 1506, which can include a digital signal processor (DSP), a special-purpose processor, and/or the like.

I/O subsystem 1508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1500 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1500 may comprise a storage subsystem 1518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1504 provide the functionality described above. Storage subsystem 1518 may also provide a repository for storing data used in accordance with the present disclosure.

As depicted in the example in FIG. 15, storage subsystem 1518 can include various components including a system memory 1510, computer-readable storage media 1522, and a computer readable storage media reader 1520. System memory 1510 may store program instructions that are loadable and executable by processing unit 1504. System memory 1510 may also store data that is used during the execution of the instructions and/or data that is generated during the execution of the program instructions. Various different kinds of programs may be loaded into system memory 1510 including but not limited to client applications, Web browsers, mid-tier applications, relational database management systems (RDBMS), virtual machines, containers, etc.

System memory 1510 may also store an operating system 1516. Examples of operating system 1516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1500 executes one or more virtual machines, the virtual machines along with their guest operating systems (GOSs) may be loaded into system memory 1510 and executed by one or more processors or cores of processing unit 1504.

System memory 1510 can come in different configurations depending upon the type of computer system 1500. For example, system memory 1510 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1510 may include a basic input/output system (BIOS) containing basic routines that help to transfer information between elements within computer system 1500, such as during start-up.

Computer-readable storage media 1522 may represent remote, local, fixed, and/or removable storage devices plus storage media for temporarily and/or more permanently containing, storing, computer-readable information for use by computer system 1500 including instructions executable by processing unit 1504 of computer system 1500.

Computer-readable storage media 1522 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1522 may include, but is not limited to, Zip® drives, flash memory cards, universal serial bus (USB) flash drives, secure digital (SD) cards, DVD disks, digital video tape, and the like. Computer-readable storage media 1522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1500.

Machine-readable instructions executable by one or more processors or cores of processing unit 1504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1524 provides an interface to other computer systems and networks. Communications subsystem 1524 serves as an interface for receiving data from and transmitting data to other systems from computer system 1500. For example, communications subsystem 1524 may enable computer system 1500 to connect to one or more devices via the Internet. In some embodiments communications subsystem 1524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1524 can provide wired network connectivity (e.g., Ethernet) in addition to or instead of a wireless interface.

In some embodiments, communications subsystem 1524 may also receive input communication in the form of structured and/or unstructured data feeds 1526, event streams 1528, event updates 1530, and the like on behalf of one or more users who may use computer system 1500.

By way of example, communications subsystem 1524 may be configured to receive data feeds 1526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1524 may also be configured to receive data in the form of continuous data streams, which may include event streams 1528 of real-time events and/or event updates 1530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1524 may also be configured to output the structured and/or unstructured data feeds 1526, event streams 1528, event updates 1530, and the like to one or more databases that may be in communication with one or more streaming data source computers coupled to computer system 1500.

Computer system 1500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1500 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method, comprising:
monitoring a cloud-computing environment comprising a set of resources, the set of resources being previously deployed to the cloud-computing environment as part of executing an automated deployment process, the set of resources being deployed by the automated deployment process based at least in part on a predefined cloud-computing architecture;
maintaining, for the set of resources of the cloud-computing environment, approved state data indicating an approved state of the set of resources of the cloud-computing environment;
receiving drift data indicating a difference between a requested state of the set of resources and the approved state of the set of resources;
identifying an entity to which the difference is attributable; and
responsive to determining that the entity to which the difference is attributable is allowed to modify one or more resources corresponding to the difference, performing one or more operations to modify the set of resources in accordance with the requested state.

2. The computer-implemented method of claim 1, wherein the drift data is first drift data, and wherein the computer-implemented method further comprises:
receiving second drift data indicating a second difference between a corresponding requested state of an additional resource of the cloud-computing environment and a corresponding approved state of the additional resource, the additional resource having been deployed using an additional predefined code module that specifies an additional deployed state of the additional resource; and
determining aggregated drift data associated with the cloud-computing environment based at least in part on combining the first drift data and the second drift data, wherein performing the one or more operations is further based on the aggregated drift data.

3. The computer-implemented method of claim 1, further comprising:
causing the difference to be presented at a user interface;
receiving, from the user interface, user input indicating a modification corresponding to the difference is approved, wherein performing the one or more operations is further based at least in part on determining that the user input indicates the modification corresponding to the difference is approved.

4. The computer-implemented method of claim 1, further comprising maintaining a last approved state of the set of resources, wherein performing the one or more operations comprises updating the last approved state of the set of resources.

5. The computer-implemented method of claim 1, wherein the requested state is received in a change request, and wherein the computer-implemented method further comprises:
determining whether the entity to which the difference is attributable is allowed to modify the one or more resources corresponding to the difference; and
rejecting the change request based at least in part on determining that the entity to which the difference is attributed is not allowed to modify the one or more resources corresponding to the difference.

6. The computer-implemented method of claim 5, wherein determining that the entity to which the difference is attributable is allowed to modify one or more resources comprises identifying that the entity to which the difference is attributable is a resource manager configured to deploy resources to the cloud-computing environment.

7. The computer-implemented method of claim 1, further comprising maintaining a plurality of change policies, wherein determining that the entity to which the difference is attributable is allowed to modify the one or more resources corresponding to the difference is based at least in part on identifying a change policy of the plurality of change policies, the change policy being associated with the entity and indicating that the entity is allowed to modify corresponding resources associated with a resource type.

8. A computing device, comprising:
one or more processors; and
one or more memories that store computer-executable instructions that, when executed by the one or more processors, cause the computing device to:
monitor a cloud-computing environment comprising a set of resources, the set of resources being previously deployed to the cloud-computing environment as part of executing an automated deployment process, the set of resources being deployed by the automated deployment process using a predefined code module that specifies a deployed state of the set of resources;
maintain, for the set of resources of the cloud-computing environment, expected state data indicating an expected state of the set of resources of the cloud-computing environment;
receive drift data that indicates a change to a resource of the set of resources of the cloud-computing environment has occurred;
determine that the change is attributable to an entity; and
perform one or more operations based at least in part on determining that the change is attributable to the entity.

9. The computing device of claim 8, wherein the drift data is received from a resource manager configured to deploy resources to the cloud-computing environment.

10. The computing device of claim 8, wherein executing the computer-executable instructions that determine the change is attributable to the entity further causes the computing device to:
determine whether the entity is a resource manager configured to deploy resources within the cloud-computing environment, wherein performing the one or more operations is further based on determining whether the entity is the resource manager.

11. The computing device of claim 8, wherein performing the one or more operations is further based at least in part on determining that the entity is a code module associated with a deployment.

12. The computing device of claim 8, wherein executing the computer-executable instructions that determine the change is attributable to the entity further causes the computing device to:
obtain, from a resource type manager, metadata associated with the resource of the set of resources; and
identify the entity from the metadata associated with the resource based on identifying, from the metadata, that the entity caused a last modification of the resource.

13. The computing device of claim 8, wherein executing the computer-executable instructions further causes the computing device to:
determine that the entity is a user; and
determine, from one or more predefined policies, whether the user is allowed to modify the resource.

14. The computing device of claim 8, wherein the one or more operations comprise:
automatically allowing the change to persist.

15. A non-transitory computer-readable medium comprising one or more memories storing computer-executable instructions that, when executed by one or more processors, cause the one or more processors to:
monitor a cloud-computing environment comprising a set of resources, the set of resources being previously deployed to the cloud-computing environment as part of executing an automated deployment process according to a predefined architectural template that specifies a post-deployment state of the set of resources and an architecture framework of the cloud-computing environment;
maintain, for the set of resources of the cloud-computing environment, expected state data indicating an expected state of the set of resources of the cloud-computing environment;
receive drift data that indicates a change to a resource of the set of resources of the cloud-computing environment;
determine that the change is attributable to an entity; and
perform one or more operations based at least in part on determining that the change is attributable to the entity.

16. The non-transitory computer-readable medium of claim 15, wherein the one or more operations performed comprises applying the change to the resource, and wherein executing the computer-executable instructions further causes the one or more processors to update the expected state data based at least in part on applying the change to the resource.

17. The non-transitory computer-readable medium of claim 15, wherein executing the computer-executable instructions further causes the one or more processors to:
maintain a plurality of policies, at least one policy of the plurality of policies indicating that the entity is allowed to modify resources of a first resource type; and
determine that the resource is associated with the first resource type, wherein the one or more operations performed comprise effectuating the change, and wherein the one or more operations are performed further based at least in part on determining that the resource is associated with the first resource type.

18. The non-transitory computer-readable medium of claim 15, wherein executing the computer-executable instructions further causes the one or more processors to:
maintain a plurality of policies, at least one policy of the plurality of policies indicating that the entity is allowed to modify resources of a first resource type; and
determine that the resource is associated with a second resource type that differs from the first resource type, wherein performing the one or more operations comprise rejecting the change based at least in part on determining that the resource is associated with the second resource type that differs from the first resource type.

19. The non-transitory computer-readable medium of claim 15, wherein executing the computer-executable instructions further causes the one or more processors to:
present the drift data that indicates the change to the resource of the set of resources of the cloud-computing environment;
receive user input indicating the change is to be reversed; and
execute additional operations to reverse the change based at least in part on receiving the user input.

20. The non-transitory computer-readable medium of claim 15, wherein executing the computer-executable instructions further causes the one or more processors to:
present the drift data that indicates the change to the resource of the set of resources of the cloud-computing environment has occurred;
receive user input indicating the change is to be applied; and
execute additional operations to apply the change based at least in part on receiving the user input.
